(19) United States
(12) Patent Application Publication
(10) Pub. No.: US 2018/0368648 A1
(43) Pub. Date: Dec. 27, 2018

(54) ANTIMICROBIAL SPONGES

(71) Applicant: Allied Bioscience, Inc., Plano, TX (US)

(72) Inventors: Craig Grossman, Point Roberts, WA (US); Gavri Grossman, Point Roberts, WA (US); Daniel Moros, New York, NY (US)

(73) Assignee: Allied Bioscience, Inc., Plano, TX (US)

(21) Appl. No.: 16/013,750

(22) Filed: Jun. 20, 2018

Related U.S. Application Data
(60) Provisional application No. 62/524,323, filed on Jun. 23, 2017.

(51) Int. Cl. A47L 13/16; A01N 55/00; A01N 33/08; A01N 25/34

(52) U.S. Cl. CPC A47L 13/16; A01N 25/34; A01N 33/08; A01N 55/00

(57) ABSTRACT

The disclosure provides an antimicrobial sponge comprising: a porous sponge substrate; and an antimicrobial coating composition dried therein, the composition comprising: at least one organosilane of formula (R¹O)₃Si—R²—Z; and an organic amine of formula R⁹R¹⁰R¹¹N, wherein each R¹ is independently H, alkyl, substituted alkyl, aryl, or substituted aryl, R² is a bivalent linker, and Z is a nucleophile, a leaving group or a quaternary nitrogen substituent, and wherein R⁹, R¹⁰, and R¹¹ are independently H, alkyl, substituted alkyl, aryl, substituted aryl or cyclic.

### CROSS-REFERENCE TO RELATED APPLICATIONS

This application claims priority to and the benefit of U.S. Provisional Patent Application Ser. No. 62/524,323 filed Jun. 23, 2017 and entitled “ANTIMICROBIAL SPONGES,” the disclosure of which is incorporated herein by reference in its entirety for all purposes.

### FIELD

This disclosure relates to natural and synthetic sponges such as, for example, institutional and household washing and cleaning sponges. In particular, the disclosure relates to antimicrobial coatings for sponges that prevent microbial growth in the sponge over time and the use of sponges for the delivery of antimicrobial coating compositions to surfaces.

### BACKGROUND

Household cleaning sponges (e.g., kitchen sponges) are known to harbor microbial growth. Studies have shown that the use of antibacterial products (e.g., antibacterial dishwashing liquid) to reduce microorganisms in kitchen sponges and cleaning cloths does not significantly reduce organisms in used sponges in which food residues are present (see H. D. Kusumaningrum, et al., Journal of Food Protection, 65,(1), 621-65, 2002). Such studies suggest that the very structure of a sponge is the problem, namely trapping organic materials in the cellular structure of the sponge where it becomes a food source for the proliferation of microbes. Only microwaving a wet sponge and mechanical dishwashing have been shown to reduce the microbial load in a contaminated sponge. Further, many synthetic household sponges are sold wetted with a triclosan solution or a quaternary disinfectant solution; however, the triclosan or a quat is quickly washed away from a new sponge and is no longer available to reduce germ counts over the life of the sponge.

Antimicrobial sponges, that is, sponges having antimicrobial treatment built into the sponge to prevent microbial growth in the sponge, are known. Such products include, for example, Lysol® Multi-Purpose Scrubber Sponge (from Reckitt-Benckiser), Libman® Antibacterial Sponge (from Libman), and NanoSponge® (from Water Liberty). The nature of these products is not clear, and it is possible that they are designed to only control the proliferation of odor causing bacteria in the sponge, and it is not clear how long the antimicrobial effect can last.

Notwithstanding these and other achievements in the field of antimicrobial sponges, new coatings and methods of coating sponges are still needed. In particular, new antimicrobial sponges are still needed for both the professional and consumer markets.

### SUMMARY

It has now been discovered that, under the proper reaction and application conditions, certain organosilanes and organic amine mixtures can be applied to and dried within sponges to make antimicrobial sponges. Such antimicrobial sponges find particular use as household sponges and food service kitchen sponges because the sponges continue to resist fowling by entrapped odor causing bacteria. Further, such sponges mitigate transmission of food borne illnesses and other diseases by not harboring and allowing proliferation of disease causing pathogens in the sponge.

In various embodiments, an antimicrobial sponge comprises: a porous sponge substrate; and an antimicrobial coating composition dried therein, the composition comprising: at least one organosilane of formula (R¹O)₃Si—R²—Z; and an organic amine of formula R⁹R¹⁰R11N, wherein each R¹ is independently H, alkyl, substituted alkyl, aryl, or substituted aryl, R² is a bivalent linker, and Z is a nucleophile, a leaving group or a quaternary nitrogen substituent, and wherein R⁹, R¹⁰, and R¹¹ are independently H, alkyl, substituted alkyl, aryl, substituted aryl or cyclic.

The porous sponge substrate may comprise a natural animal sponge, a natural plant sponge, or a synthetic sponge. The synthetic sponge may be a polyester sponge, a polyurethane sponge, or a cellulose sponge.

In various embodiments, each R¹ is independently H or alkyl, R² is —CH₂CH₂CH₂—, and Z is —NH₂. In other aspects, each R¹ is independently H or alkyl, R² is —CH₂CH₂CH₂—, and Z is a halogen. In certain instances, each R¹ is independently H or alkyl, and Z is —N(CH₃)₂(n-C₁₈H₃₇)⁺X⁻, wherein X⁻ is a halogen.

In various embodiments, the organic amine comprises at least one of diethanolamine and triethanolamine.

The organosilane may be selected from the group consisting of 3-(trimethoxysilyl) propyldimethyloctadecylammonium chloride, 3-(trihydroxysilyl) propyldimethyloctadecylammonium chloride, 3-chloropropyltrimethoxysilane, 3-chloropropylsilanetriol, 3-aminopropyltriethoxysilane, 3-aminopropylsilanetriol, and mixtures thereof, and the organic amine may comprise triethanolamine.

In specific embodiments, the antimicrobial coating composition dried therein consists essentially of 3-(trihydroxysilyl) propyldimethyloctadecylammonium chloride, 3-chloropropyltrimethoxysilane, and triethanolamine. Such an antimicrobial sponge exhibits a greater than 3 log kill of S. epidermidis ATCC 12228 2 hours after inoculation of the antimicrobial sponge with a culture of S. epidermidis ATCC 12228 when the porous sponge substrate is a cellulose sponge.

In other examples, the antimicrobial coating composition dried therein consists essentially of 3-aminopropyltriethoxysilane and triethanolamine. Such a sponge exhibits a greater than 4 log kill of S. epidermidis ATCC 12228 1 hour after inoculation of the antimicrobial sponge with a culture of S. epidermidis ATCC 12228 when the porous sponge substrate is a cellulose sponge. Further, such an antimicrobial sponge exhibits a greater than 2 log kill of E. coli ATCC 25922 2 hours after inoculation of the antimicrobial sponge with a culture of E. coli ATCC 25922 when the porous sponge substrate is a cellulose sponge.

In various embodiments, the present disclosure provides a method of preparing an antimicrobial sponge. The method comprises: soaking a porous sponge substrate in an aqueous antimicrobial coating composition comprising: (i) at least one of 3-(trimethoxysilyl) propyldimethyloctadecylammonium chloride, 3-(trihydroxysilyl) propyldimethyloctadecylammonium chloride, 3-chloropropyltrimethoxysilane, 3-chloropropylsilanetriol, 3-aminopropyltriethoxysilane, and 3-aminopropylsilanetriol; (ii) triethanolamine; and (iii) water; optionally expressing the aqueous antimicrobial coating composition out from the porous sponge substrate such as by wringing it out; and drying the porous sponge substrate to obtain the antimicrobial sponge.

In various examples, the porous sponge substrate comprises a natural animal sponge, a natural plant sponge, or a synthetic sponge. Further, the synthetic sponge may be a polyester sponge, a polyurethane sponge, or a cellulose sponge.

In various aspects, the aqueous antimicrobial coating composition used to make the antimicrobial sponge comprises 3-(trihydroxysilyl) propyldimethyloctadecylammonium chloride, 3-chloropropyltrimethoxysilane, and triethanolamine. In specific examples, the aqueous antimicrobial coating composition consists essentially of 0.75 wt. % 3-(trihydroxysilyl) propyldimethyloctadecylammonium chloride, 0.12 wt. % 3-chloropropyltrimethoxysilane, and 0.045 wt. % triethanolamine, remainder water, where the weight percentages are based on the total weight of the composition.

In other aspects, the aqueous antimicrobial coating composition used to make the antimicrobial sponge comprises 3-aminopropyltriethoxysilane, triethanolamine, and water. In more specific examples, the aqueous antimicrobial coating composition consists essentially of 9.41 wt. % 3-aminopropyltriethoxysilane and 0.31 wt. % triethanolamine, remainder water, where the weight percentages are based on the total weight of the composition.

In various embodiments, an antimicrobial sponge in accordance to the present disclosure may be packaged dry, damp, wet, expanded or compressed in a suitable package, such as a cellophane wrapper or a carton.

### DETAILED DESCRIPTION

The detailed description discloses exemplary embodiments and best mode. While these exemplary embodiments are described in sufficient detail to enable those skilled in the art to practice the invention, it should be understood that other embodiments may be realized and that chemical and mechanical changes may be made without departing from the spirit and scope of the inventions. Thus, the detailed description is presented for purposes of illustration only and not of limitation. For example, unless otherwise noted, the steps recited in any of the method or process descriptions may be executed in any order and are not necessarily limited to the order presented. Equivalent chemical species may be substituted in various compositions. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

In various embodiments, antimicrobial coating compositions for use with natural and synthetic sponges or their starting materials are disclosed. In various embodiments, antimicrobial coating compositions comprise at least one of an organosilane, an organic amine, a titanium (IV) species, a mixture of peroxotitanium acid and peroxo-modified anatase sol, and a parylene polymer, in any combination. Antimicrobial coating compositions provide residual antimicrobial coatings on sponges when applied thereon. In various embodiments, coatings on sponges treated with the compositions herein mitigate microbe proliferation by providing a residual antimicrobial effect on the surface of the sponge, throughout the practical lifetime of the sponge, even in repeated contact with soaps and detergents.

As used herein, the term “organosilane” refers to silicon-containing organic chemicals, as opposed to inorganic forms of silicon, such as SiO₂ and water glass species (Na₂SiO₃, and the like). An organosilane is typically a molecule including carbon and silicon atoms, but may also include any other heteroatoms such as oxygen, nitrogen, or sulfur. Organosilane compounds may be chemical reactive or inert, and may be monomeric, dimeric, trimeric, tetrameric, or polymeric. Organosilane monomers may be chemically reactive in that they at least partially hydrolyze or polymerize, or form various adducts and/or polymers with other chemical species. Exemplary organosilanes include, but are not limited to, organosilanes having three reactive, e.g. hydrolysable, groups on silicon and one non-hydrolyzable group on silicon, such as one forming a C—Si bond. Such exemplary organosilanes include, for example, 3-(trimethoxysilyl) propyldimethyloctadecyl ammonium chloride, 3-chloropropyltrialkoxysilane and 3-aminopropyltrialkoxysilane, and any of their corresponding adducts, hydrolysis products, self-condensation products, and polymeric reaction products therefrom.

As used herein, the term “titanium species” refers to any chemical compound in any oxidation state, regardless if monomeric, dimeric, trimeric, or polymeric, comprising at least one titanium atom. Non-limiting examples include titanium (IV) oxide (TiO₂) in any form, other Ti(IV) species, (e.g. TiCl₄, Ti—(O-i-C₃H₇)₄ or any other Ti(IV) alkoxide, phenoxide or halide). Any “form” of (TiO₂) includes nanoparticles, photocatalytic thin films produced by a sol-gel process, mixtures of peroxotitanium acid and peroxo-modified anatase sol, and the like. Titanium species for use in various embodiments may be white or transparent, and may be photocatalytic (and by themselves antimicrobial), or not photocatalytic. A titanium species may be disposed on sponge surfaces to produce an antimicrobial coating or used as a bonding agent to bond other substances, such as organosilanes, to the surfaces of the sponge to form a more durable antimicrobial coating on sponges.

As used herein, the term “adduct” refers to a chemical combination of two or more chemical species, regardless of what forces hold the particular combination together.

For example, two chemical species may form an adduct that comprises an ionic or covalent bond between the species, or even van der Waals or hydrogen bonds. A non-limiting example is the adduct (MeO)₃Si—CH₂CH₂CH₂—N(CH₂CH₂OH)₃⁺Cl⁻ resulting from the reaction, under certain conditions, between 3-chloropropyltrimethoxysilane and triethanolamine. Another non-limiting adduct is the hydrogen bonded chelate resulting from the association between triethanolamine and 3-aminopropyltriethoxysilane, wherein the —OH groups of the triethanolamine are hydrogen bonded to the —NH₂ group of the organosilane. Adducts for use in various embodiments herein do not need to include an organosilane, as they may be formed, for example, from the combination of other molecular species. A non-limiting example of such an adduct not comprising silicon is the compound resulting from reaction of a titanium (IV) species such as Ti—(O-i-C₃H₇)₄ and a diol.

As used herein, the term “polymer” takes on its ordinary meaning, which is at least two monomer species linked together to form any larger molecular weight compound. For the sake of simplicity, a polymer includes at least four monomers so as to distinguish from a dimer, trimer and tetramer. Thus, as few as five monomers covalently linked together comprise a polymer for purposes for use in various embodiments. In accordance with the ordinary meaning, a polymer may include any combination of any monomeric species, and may be linear, branched or other configuration (e.g. dendritic). Further, a polymer may be organized as a homo-polymer of one monomer or any type of co-polymer having more than one monomeric species (block, random, etc.). A polymer may have a recognizable repeating structure, such as having a defined backbone, or may have branched and random structure with multiple sets of repeating units or a structure that cannot be easily described due to the randomness. Polymers for use in various embodiments may have undefined molecular size and structure. In instances wherein complete structural elucidation is not possible, polymers may be denoted as having n repeating units, wherein n=1 to infinity. In various embodiments, polymers may also comprise adducts. One such non-limiting example is a grafted polymer formed by derivatization of a parylene polymer with an organosilane.

As used herein, the term “parylene” refers to the broad genus of (poly)-p-xylylene polymers, with the general formula —[CH₂—C₆H₄—CH₂]ₙ— representing the unsubstituted polymer referred to as parylene-N. The phenyl ring of the p-xylylene group may be substituted, such as with one chlorine atom (parylene-C), —[CH₂—C₆H₃Cl-CH₂]ₙ—, or two chlorine atoms, (parylene-D), —[CH₂—C₆H₂Cl₂—CH₂]ₙ—. In various embodiments, parylene polymers are grafted with organosilane chains, such as to form parylene polymers having a —CH₂CH₂CH₂—Si(OR¹)₃ substituent on each one of the p-xylylene repeating groups.

As used herein, the term “alkyl” refers to any linear, branched or cyclic monovalent carbon containing radical, such as, for example, methyl, ethyl, n-propyl, i-propyl, n-butyl, i-butyl, t-butyl, cyclopropyl, cyclohexyl, and the like. A “substituted alkyl” substituent refers to the above alkyl group that also bears at least one other group including a heteroatom, such as an —OH, —SH, —OCH₃ or —CO₂H substituent, or at least one intervening heteroatom positioned in the carbon chain of the alkyl group. Thus, a substituted alkyl group includes such monovalent species as —CH₂—O—CH₃, and —CH₂CH₂—N(CH₃)—CH₂CH₃. Since alkyl groups may be cyclic, “substituted alkyl group” also encompasses all non-aromatic heterocyclic species. A non-limiting example of the latter is a 1-morpholinyl substituent.

As used herein, a “bivalent linker R” group refers to any bivalent alkylene residue, for example, methylene, propylene, butylene, and the like, with any degree of unsaturation and/or branching. A bivalent linker “R” may also include a substituent group on the linker, and/or one or more intervening heteroatoms. In this case, a “bivalent linker” refers to all bivalent alkylene moieties, regardless if substituted with various functional groups or containing intervening heteroatoms. Examples of a bivalent linker include, but are not limited to, —CH₂CH₂CH₂— and —CH₂—O—CH₂CH₂—, and so forth.

When referring to at least two substituents “R” bonded to a common atom, such as R⁹R¹⁰R¹¹N, the option of “cyclic’ refers to the situation wherein at least two of the “R” substituents form a ring structure that includes the common atom to which the “R” groups are bonded. Thus, as an example, the genus structure R⁹R¹⁰ R¹¹N, wherein R⁹, R¹⁰, and R¹¹ are alkyl, includes N-methylpyrrolidine, amongst many other chemical species.

As used herein, the term “aryl” takes on the ordinary meaning of an aromatic substituent, including phenyl and any heteroaryl, e.g. pyridyl, imidazoyl, and the like. A “substituted aryl” refers to a substituted phenyl group or a substituted heteroaryl moiety, wherein the substitution is in any position around the aromatic ring, and in any combination.

As used herein, the term “nucleophile” takes on the ordinary meaning in organic chemistry, which refers to a substituent capable of donating an electron pair to an electrophilic species to form a chemical bond. Examples of neutral substituents that would be considered nucleophilic substituents attached to a chemical species include, but are not limited to, —OH, —SH, —NH₂, —NHR⁸, and —NR⁹R¹⁰. Thus, a molecular species such as R—OH is considered nucleophilic because it contains the nucleophilic hydroxyl substituent —OH. Anionic substituents are also considered nucleophilic. Examples include, but are not limited to, —O⁻, —S⁻, —CO₂⁻, and the like.

As used herein, the term “leaving group” takes on the ordinary meaning in the field of organic chemistry, which refers to a molecular fragment or substituent that departs from a molecular species with a pair of electrons upon heterolytic bond cleavage. Chemical reactions for use in various embodiments may comprise the reaction between a nucleophile and an electrophilic atom having a leaving group attached thereto, which results in a new bond formed between the nucleophile and the electrophilic atom and the departing of the leaving group (i.e. an Sn2-type reaction). As examples for use in various embodiments, an amine (nucleophile) may displace a halogen (leaving group) from a carbon atom resulting in a new C—N bond and the expulsion of the halogen, or a tertiary amine (nucleophile) may displace a halogen (leaving group) from a carbon atom resulting in a new quaternary ammonium compound having C bonded to a positively charged N that has three other appendages (i.e. quaternary). In this case, the halogen is the negatively charged counterion to the quaternary/positively charged N.

As used herein, the term “sponge” takes on its ordinary and customary meaning of a soft, light, porous substance, such as used for washing, cleaning, mopping, personal care and other consumer and institutional tasks. In most instances, a sponge is a porous substrate with an internal network of cells, cavities, and channels capable of holding at least some liquid in these confines, which can be expressed back out of the structure by squeezing, wringing or otherwise compressing the structure to force the liquid back out of the inner structure. To address various embodiments, the distinction is made between natural sponges and synthetic sponges. As used herein, the term “natural sponge” refers to sponges found and harvested directly from the environment. For example, natural sponges include animal sponges, such as the sea sponges of the Porifera phylum, and plant sponges, such as Luffa Aegyptiaca. Natural animal sponges include, but are not limited to, yellow sea sponges, wool sea sponges, Caribbean silk sponges, and grass sea sponges. As used herein, the term “synthetic sponge” refers to a manmade sponge, regardless that it may be made from natural materials. For example, synthetic sponges herein include cellulosic sponges, such as those made from wood pulp and hemp fibers, along with the chitosan sponges and starch sponges, because they are manmade and not found in the environment. Synthetic sponges also include sponges made from synthetic materials, such as foamed polyurethane, and any synthetic sponge may comprise a closed cell or open cell structure. Synthetic sponges may comprise a foamed polymer. These include, but are not limited to, polyurethane, polyethylene, polypropylene, polyvinyl acetate, low density polyether, acrylates including methacrylates, methacryloyloxybenzophenone (MABP), melamine foam, polystyrene, urea-formaldehyde, and polyester, and any combinations thereof, including co-polymers. Types of synthetic sponges include blown and double blown. Polyester sponges can be subdivided into a variety of types, some of which are reticulated for ease of use. One type known as double-blown polyester has a high water-retention capability approaching or equaling that of polyvinyl acetate sponges, but with visible pores and more diverse uses.

The sponges may comprise both a natural sponge portion and a synthetic sponge portion. The sponge may comprise an additional portion such as a plastic scouring pad layer, and that additional portion may comprise a different chemical makeup than the sponge portion. Also, the sponge may be attached to anything, including a cord or a tool, such as a handle, and may be of any size, shape, porosity, texture, flexibility, compressibility, chemical composition, and cellular structure.

Natural and synthetic sponges, such as these and others, may be treated with the compositions herein, and the treated sponges will retain a residual antimicrobial efficacy on its surfaces before it is disposed of, that is, through the practical lifetime of the sponge. Natural sponges are generally harvested “as is,” and thus the treatment to make a natural sponge antimicrobial may be simply to saturate the animal or plant sponge with one or more antimicrobial coating compositions, express the liquid back out of the sponge such as by compressing it, and then optionally curing the coating within and throughout the sponge, such as by drying. For synthetic sponges, the treatment to make the sponge antimicrobial may occur at any step in the manufacture of the synthetic sponge. For a completed sponge, such as a retail kitchen sponge, the process may be the same as the process used for the natural sponge (simple wetting and expression of the excess liquid composition). However, in other embodiments, wood pulp and/or hemp fibers, chitosan, or any other starting materials used in the manufacture of synthetic sponges, may first be treated with the antimicrobial coating compositions before the synthetic sponge is formed from these materials. In other embodiments, antimicrobial treatment may coincide with the foaming of a polymer in the manufacture of a synthetic sponge. For example, one or more antimicrobial coating compositions may be mixed with a polymer such as polyurethane before the polyurethane is foamed into a sponge structure by use of a propellant. In other embodiments, one or more antimicrobial coating compositions may form a separate phase with an organic polymer, such as in a dispersion used in the manufacture of a synthetic sponge, wherein the cell structure is created, for example, by the aqueous phase droplets dispersed in the organic polymer.

In various embodiments, the treatment of a natural sponge or a finished synthetic sponge with one or more antimicrobial coating compositions comprises a complete saturation of the inner cell structure of the sponge with the composition. This may require a repetition of saturation and expression cycles in order to get the liquid composition deep into the cell structure and to ensure all of the channels, cells and cavities internal to the sponge are flooded with composition.

In various embodiments, a natural or synthetic sponge is used to deliver antimicrobial coating compositions to various hard or soft surfaces, and then the sponge retains a residual antimicrobial effect within its structure such that the sponge resists fowling. For these embodiments, a sponge may be wetted to any degree with one or more antimicrobial coating compositions, and packaged appropriately to retain the wetness. Sponges may be wetted and then sealed in cellophane packaging, for example. In various embodiments, a sponge on the end of a hollow handle, such as those seen in household hand dishwashing applications, may be filled with one or more antimicrobial compositions, and the composition is delivered into the sponge from the dispensing handle.

In various embodiments, antimicrobial coatings on the soft surfaces around and inside a sponge remain bonded to the sponge, and the sponge retains a residual antimicrobial efficacy in the presence of washing, rinsing, and bacterial loading. These processes are common to household cleaning, particularly kitchen cleaning, where sponges are repeatedly exposed to dishwashing liquid, running water rinsing, and food particle entrapment.

As used herein, the phrase “on a sponge,” in the context of treating a sponge with an antimicrobial coating composition, means that the inner structure of the sponge, i.e. the walls surrounding the inner voids in the interior of the sponge, are exposed to the antimicrobial coating composition. Thus, a sponge may suck up antimicrobial coating composition such that the liquid composition is held “in the sponge.” However, the actives in the antimicrobial coating composition may bond “on the sponge,” meaning the antimicrobial actives are bonded to the surface of the sponge substrate, the cellular structure within the interior of the sponge, and also on the visible exterior surfaces.

As used herein, the term “antimicrobial” is used generally to indicate at least some degree of microbe kill by an antimicrobial coating composition or a residual antimicrobial coating formed on and within a sponge upon treatment with an antimicrobial coating composition. For example, the term antimicrobial may be used as an indication of a sanitizing level (3-log, or 99.9%) reduction in at least one organism, or a disinfection level (5-log, or 99.999%) reduction in at least one organism, or a sterilization level (no detectable organisms) reduction in at least one organism. Microbes, or microorganisms, may include any species of bacteria, virus, mold, yeast, or spore, such as food borne organisms like Salmonella, Shigella, E. coli and Campylobacter. The terms “residual antimicrobial,” “residual self-sanitizing,” and “self-decontaminating surface” are used interchangeably to indicate a soft surface of a sponge that maintains antimicrobial efficacy over a certain period of time under certain conditions once the sponge is treated and coated with an antimicrobial coating composition and cured in some manner. The ability for a treated sponge to control bacteria therein may be seen by slicing open a treated sponge and testing zone of inhibition, or applying a dye on the slice of sponge to show a continued presence of an antimicrobial, and so forth. A coated sponge may maintain residual antimicrobial efficacy indefinitely, or the coating may eventually “wear out” and lose its residual antimicrobial efficacy. In various aspects, a sponge, such as a disposable kitchen cleaning sponge, is disposed of before the sponge loses its residual antimicrobial efficacy. A treated sponge may have different responses upon exposure to gram-negative bacteria versus gram-positive bacteria, simply because a culture of bacteria remains as a liquid inside the cells of the sponge.

An antimicrobial coating composition has the ability to leave behind a residual antimicrobial coating on the various soft surfaces of sponges, inside and out, once dried or cured both on and inside the sponge, which can keep inactivating new microorganisms such a food borne pathogens that come into contact with the sponge. In various embodiments, coating compositions may not become antimicrobial on and in the sponge until the compositions is dried or cured on and within the sponge structure, but are nevertheless still referred to as antimicrobial coating compositions because of their ability to produce a residual antimicrobial coating on a sponge. Antimicrobial coating compositions may impart a residual antimicrobial efficacy to a sponge, meaning that a microorganism later inoculated on or within the cellular structure of the sponge, or that otherwise comes in contact with, the coated surfaces of the sponge, may experience cell death, destruction, or inactivation. The residual antimicrobial effect made possible by the coatings is not limited by a particular mechanism of action, and no such theories are proffered. For example, an antimicrobial effect measured by inoculating a treated sponge may be the result of intracellular mutations, inhibition of certain cellular processes, rupture of a cell wall, or a nondescript inactivation of the organism. Other antimicrobial effects may include inhibiting the reproduction of an organism, or inhibiting the organism's ability to accumulate into colonies or other intercellular agglomerations.

As used herein, the term “antimicrobial coating composition” refers to a chemical composition comprising at least one chemical species, which is used to produce a residual antimicrobial coating on and within a sponge after the composition is applied to the sponge and then either dried, allowed to dry, or cured in some manner. However, the term is extended to include a composition that may be applied sequentially (e.g. over or under) or contemporaneously with the application of an antimicrobial coating composition comprising an antimicrobial active, such as to assist in bonding the residual antimicrobial coating to the surface, improve longevity of the overall coating, and/or to provide a catalytic effect or some sort of potentiation or synergy with the residual antimicrobial coating comprising an antimicrobial active. For simplicity, each one of multiple compositions used sequentially or contemporaneously to produce an overall residual antimicrobial coating on a sponge is referred to as an “antimicrobial coating composition,” even if one or more of the compositions used for treating the sponge has no identifiable antimicrobial active, or where the chemical structure of the active antimicrobial agent may be uncertain. An antimicrobial coating composition may comprise a neat, 100% active chemical species, or may comprise a solution or suspension of a single chemical species in a liquid carrier. In other aspects, a composition may comprise a complex mixture of chemical substances, some of which may chemically react (hydrolyze, self-condense, etc.) within the composition to produce identifiable or unidentifiable reaction products. For example, a monomeric chemical species in an antimicrobial coating composition may partially or fully polymerize while in solution prior to a coating process using that composition. In various embodiments, chemical constituents within an antimicrobial coating composition may chemically react on or within the sponge structure, such as while the composition is drying and concentrating on the sponge or while the coating composition is cured by various methods onto the sponge. In various examples, the sponge substrate itself may have certain catalytic effects on the antimicrobial coating compositions, such as simple pH effects, which may promote certain chemical reactions and bonding to occur. In some examples, residual materials left behind in synthetic sponges from the manufacturing process, such as polymerization initiators and catalysts, may become available to potentiate certain chemical reactions in the antimicrobial coating compositions and/or reactions between the coating compositions and the sponge material.

Antimicrobial coating compositions may further comprise any number and combination of inert excipients, such as for example, liquid carrier such as water and solvents, surfactants, emulsifiers, stabilizers, thickeners, free-radical initiators, catalysts, etc.

As used herein, the term “curing” includes all known curing methods in the chemical and engineering arts. These include, but are not limited to, ambient curing, radiation curing and chemical curing. For example, an antimicrobial coating composition applied to a sponge may be subject to UV, visible light, microwave, ion beam or other incident radiation in order to cure the composition on the surfaces of the sponge. For example, certain wavelength radiation can cure coating compositions deep within the cellular structure of a sponge provided that the sponge is not radiation absorbing. Radiation curing also includes thermal radiation methods, (i.e. heat), such as heating a coated sponge in a convection oven, a vacuum oven, or an autoclave. In other aspects, an antimicrobial coating composition may be applied on and within a sponge and then the sponge dried under ambient conditions. This latter method may be of use for natural sponges so as not to disturb the outer appearance of the sponge, which may provide a marketing aspect. Such ambient drying, drying over a heated roller, in an oven are all useful methods of curing coatings in roll coating, such as if a synthetic sponge material is in a collapsed wafer form. Ambient drying conditions may optionally include control of the percent relative humidity (% RH). Curing by any of these methods may be used to drive off volatile components such as water and solvents, and/or initiate and/or catalyze inter- or intra-molecular chemical reactions such as hydrolysis, inter- and intramolecular self-condensation, intermolecular polymerization between different species, or crosslinking of polymer chains, or covalent bonding of chemical entities to the sponge material. During curing, such as ambient drying, a coating is developed on the sponge that is durable to exposure to detergents and rinsing for a desired period of time, such as the time period the sponge is used prior to its disposal.

As used herein, the term “durable” refers to usable life of a coating under a prescribed condition. Thus, “durability” is not absolute, but is rather for a period of time under particular conditions. For example, a residual antimicrobial coating on 100% Porifera sea sponge may be deemed durable because it continues to deliver a log-3 (99.9%) reduction in a nontyphoidal Salmonella serotype on the sponge for 7-days while the sponge is in use in a household kitchen for hand dishwashing chores. For a durability assessment, a residual antimicrobial coating may be tested at discrete periods of time and after exposure to certain conditions, such as by inoculating the treated sponge in accordance with American Association of Textile Chemists and Colorists test method “AATCC 100” (entitled “Antibacterial Finishes on Textile Materials: Assessment of”) or variations thereof. Other test methods may involve panel testing with individuals ranking odor levels in kitchen sponges over time rather than measuring the remaining antimicrobial efficacy of the sponge itself. Or, the sponge itself may be examined for the presence of food borne microbes trapped in the sponge over time. For example, a swab may be inserted into the interstices of a treated sponge after several days of kitchen hand dishwashing, and the swab cultured for the presence of any microorganisms. In other examples, a treated sponge may be sectioned and tested for zone of inhibition.

In various embodiments, antimicrobial coating compositions are applied to sponges to produce a residual antimicrobial coating on and in the sponge. In many examples, the sponge will comprise a convolution of internal passageways and cavities, often referred to as the sponge's internal cellular structure. The surfaces of these passageways and cavities in the sponge are coated with an antimicrobial coating composition. In various embodiments, at least one coating composition is applied to a sponge. The application process may comprise any single application method or a combination of application methods. In various examples, different application methods may be used for each of two or more successive coatings of antimicrobial coating compositions. In various embodiments, at least one coating is applied to a sponge, and in the instances where two or more coatings are applied, the coatings may be chemically the same or different. In various embodiments, any period of time may transpire between separate coatings of a sponge, such as, seconds, minutes, hours, days, or longer.

In various embodiments, any application method used in the textile industry may be used to apply an antimicrobial coating composition to a sponge substrate or directly to a finished sponge product. Further, antimicrobial coating compositions may be applied to a component of a sponge rather than to a finished sponge. For example, bulk materials in the form of rolls may be roll coated, and then that coated material cut and used to make sponges. In a non-limiting embodiment, a variation of the common viscose process, wood pulp or other cellulose is dissolved in an antimicrobial coating composition prior to its use in the manufacture of cellulosic sponges. In various aspects, blocks of cellulose sponge substrate may be treated with an antimicrobial coating composition. In other examples, sheets of cellulose sponge substrate, such as the sheets obtained from the cutting of cellulose blocks, may be treated with an antimicrobial coating composition. Or, sheet material may be cut into the finished cellulose sponges and the finished sponges are treated with an antimicrobial coating composition. Sponges may be treated with an antimicrobial coating composition after each sponge receives a glued-on scrubbing pad.

Coating processes can be categorized as including “self-metering systems” that saturate sponge substrates and “pre-metering systems” that allow at least some control over the amount of liquid added to a sponge substrate. In either category, there are various “contact” methods and “non-contact methods,” referring to whether a substrate is touched by any device during the coating process. Various self-metering coating techniques include, but are not limited to, dipping, soaking, blade coating, and roller coating. Pre-metering techniques include, but are not limited to, gravure roll coating methods, curtain coating and screen roller coating. Depending on the configuration of the rollers, gravure coating may be offset or direct. Any of these methods are suitable for synthetic sponge substrate in the form of sheets, blocks or buns.

Roll coating methods in general have an advantage of being adaptable to roll-to-roll processes, meaning that a roll of sponge substrate is unrolled at the start of the operation, pulled through a coating process and then wound-up at the other end of the operation. Coated rolls may be cured in bulk (e.g. by simply storing rolls of coated sponge under certain conditions), or coated rolls may again be unwound, run through a curing operation and then wound-up at the other end. Coated rolls that are optionally cured may then be shipped to third party manufacturers to complete the production of the sponge. In a roll-to-roll operation, sponge material may expand in dimension during coating with liquid compositions, and then compressed to thin dimension prior to being rolled back up.

Roll coating methods for use in various embodiments include, but are not limited to, knife coating, direct roll coating, padding, and calendar roll coating. In roll coating in general, a sheet of sponge substrate is pulled through a series of rollers that are continually wetted with a composition, or a knife edge pulls a layer of liquid composition over a moving sheet of sponge, or a sheet of sponge is directed below the surface of a bath of composition and then run between nip rollers to express the excess composition back out of the sponge substrate sheet. All of these methods are designed to apply a desired amount of a composition to a sponge. In certain embodiments, the sponge substrate may be completely saturated with an antimicrobial coating composition prior to a curing step.

In various embodiments, a dip coating process is a simple and useful method for treating sponges at, or close to, retail size, and is useful for treating the natural animal and plant sponges and also for synthetic sponges. Excess liquid composition may be expressed from the sponges, such as by passing the wetted sponges between nip rollers or by placing a multitude of soaked sponges under a press. Another useful and simple method for coating sponges is to spray one or more antimicrobial coating compositions onto a moving sheet of sponge, or a conveyor carrying small sponges. In these embodiments, a spray bar can be positioned perpendicular to the length of the sponge sheet, as wide as the width of the sponge, and over the top of and optionally underneath the sheet of sponge in order to spray a prescribed amount of composition onto the moving sponge substrate. The operation may be fine-tuned such that the sponge is coated with a particular weight of composition, such as measured in grams per gram sponge material (g/g or “gpg”). When more than one coating composition is to be applied in a roll-to-roll coating operation, two spray bars can be used, one for each composition, positioned at different positions along the moving sponge line. Curing stations can be set up after the first and second coating positions, such as ovens or heated rollers, for example. In this way, a sponge roll can be unrolled, pulled under a first coating bar, pulled through a first curing station, pulled under a second coating bar, pulled through a second curing station, compressed to a thin dimension such as through rollers, and then wound-up at the end. A roll of sponge sheet material treated in this way may comprise, for example, a sheet of cellulose.

The upper limit as to how much antimicrobial coating composition may be applied to a sponge is dependent upon the liquid holding capacity of the sponge, amongst other considerations, such as, time, viscosity of the liquid, and temperature of the wetting process.

In accordance with various embodiments, a residual antimicrobial coating on a sponge may have unimolecular thickness (i.e., a monolayer), or may be macroscopically thick, such as having a microns to millimeters in thickness. The thickness may be seen on individual surfaces and structures within a sponge, such as visualized by an increase in the average thickness of a sponge cell surface once coated. In various embodiments, a residual antimicrobial coating on the surfaces of a sponge is from about 1 nm to about 1 mm in thickness. In other examples, a residual antimicrobial coating is from about 1 nm to about 100 μm in thickness. Coatings may be flexible, durable, and resistant to flaking and chipping. Thus, for example, twisting a treated and dried sponge may not produce any detectable powdery fallout from the sponge. Coatings of unimolecular thickness on the surfaces of a sponge are not perceivable to the naked eye, and may be more resistant to flaking off compared to coatings of macroscopic thicknesses, such as if a treated and dry sponge happens to be compressed or twisted in the manufacturing process or in use by the consumer.

In accordance with other embodiments, an antimicrobial coating composition may be packaged for consumer or professional use. For example, an antimicrobial coating composition may be packaged as a liquid in a bottle with a screwcap, or with a propellant in an aerosol package. Or, an antimicrobial coating composition may be packaged in a non-aerosol pump or trigger sprayer. In this way, the consumer or can spray the antimicrobial coating composition directly onto a sponge, such as to “refresh” the residual antimicrobial efficacy. In other ways, a liquid antimicrobial coating composition, such as supplied in a bottle, can be used to refill a hollow handle dispenser attached to a sponge. In various examples, both a household hand dishwashing liquid and an antimicrobial coating composition may be added into the handle of a dishwashing sponge tool.

Organosilane and Amine Coatings

In various embodiments, an antimicrobial coating composition comprises at least one organosilane of general structure (R¹O)₃Si—R²—Z, or an adduct, hydrolysis product, or polymeric reaction product therefrom, wherein R¹ is H, alkyl, substituted alkyl, aryl, or substituted aryl, R² is a bivalent linker of any molecular chain length and degree of branching, which may comprise any number of methylene groups —(CH₂)ₙ—, optionally substituted with various substituents such as —OH, —SH, —OCH₃, or —CO₂H anywhere along the chain, and/or interrupted with intervening heteroatoms and/or degrees of unsaturation, and Z is a nucleophile, a leaving group or a quaternary nitrogen substituent.

An antimicrobial coating composition may further comprise a “solvent,” otherwise referred to as a “liquid carrier,” such as water or an alkanol or mixture thereof, and/or any additional excipients such as, but not limited to, a surfactant, a quaternary ammonium salt, an inorganic silicate, an inorganic acid, and organic acid, an inorganic base or an organic base. In various examples, an organic base comprises any organic amine, such as diethanolamine or triethanolamine. In other examples, a quaternary ammonium salt comprises choline chloride or choline bitartrate, or a typical quaternary ammonium disinfectant.

In certain examples, an antimicrobial coating composition comprises at least one organosilane of general structure (R¹O)₃Si—R²—Z, wherein R¹ is H, CH₃ or CH₂CH₃, R² is —CH₂CH₂CH₂—, and Z is —NR¹²R¹³, wherein R¹² and R¹³ are independently H, alkyl, substituted alkyl, aryl, or substituted aryl. In other examples, Z is a halogen. In other more specific examples, R² is any bivalent linker, and is —NH₂, —N(CH₃)₃⁺Cl⁻, —N(CH₃)₂(n-C₁₈H₃₇)⁺Cl⁻, —OH, or —Cl. In another specific example, an antimicrobial coating composition comprises at least one organosilane of general structure (R¹O)₃Si—R²—Z, wherein R¹ is H, CH₃ or CH₂CH₃, R² is —CH₂CH₂CH₂—, and Z is —NH₂.

In accordance with various embodiments, an antimicrobial coating composition may comprise at least one of 3-(trimethoxysilyl) propyldimethyloctadecyl ammonium chloride, 3-(hydroxysilyl) propyldimethyloctadecyl ammonium chloride, 3-chloropropyltrimethoxysilane, 3-chloropropyltriethoxysilane, 3-chloropropylsilanetriol, 3-aminopropyltrimethoxysilane, 3-aminopropyltriethoxysilane, and 3-aminopropylsilanetriol.

In various examples, an antimicrobial coating composition further comprises an organic amine. An organic amine for use in various embodiments may be primary, secondary, or tertiary in nature. In general, an organic amine for use in various embodiments may comprise an amine having structure R⁹R¹⁰R¹¹N, wherein R⁹, R¹⁰, and R¹¹ are independently H, alkyl, substituted alkyl, aryl, substituted aryl or cyclic. The latter option accentuates that an organic amine for use in various embodiments may be cyclic, (i.e. any two of R⁹, R10, and R¹¹ may form a ring with the N atom in the ring). Organic amines for use in various embodiments includes ammonia, (R⁹, R¹⁰, and R¹¹ are each H). In accordance to the general structure provided, an organic amine for use in various embodiments may comprise diethanolamine or triethanolamine, amongst many other species of amines.

In various examples, an antimicrobial coating composition comprises an organosilane of structure (R¹O)₃Si—R²—Z, and at least one organic amine having structure R⁹R¹⁰R¹¹N, wherein R¹ is H, alkyl, substituted alkyl, aryl, or substituted aryl, R² is a bivalent linker, Z is a nucleophile, leaving group or quaternary ammonium substituent, and R⁹, R¹⁰, and R¹¹ are independently H, alkyl, substituted alkyl, aryl, substituted aryl, or cyclic. Depending on the choices for these variables, there may be chemical reactions between the organosilane and the organic amine(s) in solution or on a surface, or no chemical reactions at all.

An antimicrobial coating composition may comprise at least one of 3-(trimethoxysilyl) propyldimethyloctadecyl ammonium chloride, 3-(hydroxysilyl) propyldimethyloctadecyl ammonium chloride, 3-chloropropyltrimethoxysilane, 3-chloropropyltriethoxysilane, 3-chloropropylsilanetriol, 3-aminopropyltrimethoxysilane, 3-aminopropyltriethoxysilane, and 3-aminopropylsilanetriol, in any combination, and at least one of diethanolamine and triethanolamine. An antimicrobial coating composition may further comprise any solvent such as water or any alkanol or any mixture of solvents.

An antimicrobial coating composition may comprise at least one of 3-aminopropyltrimethoxysilane, 3-aminopropyltriethoxysilane, and 3-aminopropylsilanetriol, along with a choline salt such as choline chloride or choline bitartrate.

In various examples, an antimicrobial coating composition comprises an organosilane of structure (R¹O)₃Si—R²—Z that may undergo hydrolysis in aqueous or alkanol solution. For example, an antimicrobial coating composition comprising 3-chloropropyltrimethoxysilane and water may also comprise 3-chloropropylsilanetriol and methanol. In certain embodiments, forming an antimicrobial coating composition comprising 3-chloropropyltrimethoxysilane in water results in an antimicrobial coating composition comprising 3-chloropropylsilanetriol, water, and methanol.

An antimicrobial coating composition comprising an organosilane of structure (R¹O)₃Si—R²—Z and optionally any other excipient such as an alkanol or amine, may be applied to a sponge to form a residual antimicrobial coating on and within the sponge. Any method of application, or known in the textile industries, may be used, such as roll-to-roll or dip coating. The treated sponge may then be air dried, heated or exposed to some other radiation to cure the antimicrobial coating composition into a residual antimicrobial coating within the sponge. Curing may comprise ambient drying or heated drying such as in a convection oven.

As mentioned, treated sponges may be left wetted with one or more antimicrobial coating compositions, so that the sponge can be used to apply antimicrobial coating compositions to surfaces, in addition to retaining a residual antimicrobial efficacy in its structure.

In various embodiments, a residual antimicrobial coating on a sponge comprises at least one organosilane of general structure (R¹O)₃Si—R²—Z, or an adduct, hydrolysis product, or polymeric reaction product therefrom, wherein R¹ is H, alkyl, substituted alkyl, aryl, or substituted aryl, R² is a bivalent linker of any molecular chain length and branching, which may comprise any number of methylene groups —(CH₂)ₙ—, optionally substituted with various substituents such as —OH, —SH, —OCH₃, or —CO₂H anywhere along the chain, and/or interrupted with intervening heteroatoms and/or degrees of unsaturation, and Z is a nucleophile, a leaving group or a quaternary nitrogen substituent. In certain examples, a residual antimicrobial coating further comprises an organic amine having structure R⁹R¹⁰R¹¹N, wherein R⁹, R¹⁰, and R¹¹ are independently H, alkyl, substituted alkyl, aryl, substituted aryl or cyclic.

A residual antimicrobial coating on a sponge comprises a silsesquioxane. In various embodiment, a silsesquioxane comprises the structure:

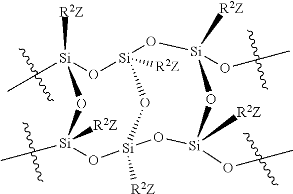

wherein R² is a bivalent linker of any molecular chain length, which may comprise any number of methylene groups —(CH₂)ₙ—, optionally substituted with various substituents such as —OH, —SH, —OCH₃, or —CO₂H anywhere along the chain, and/or interrupted with intervening heteroatoms and/or degrees of unsaturation, and Z is a nucleophile, a leaving group or a quaternary nitrogen substituent. In other embodiments, a residual antimicrobial coating on a sponge comprises a silsesquioxane having any other known or unknown silsesquioxane structure, such as, any oligomeric, polymeric or cage-like structure, including open and closed cages.

A residual antimicrobial coating on a sponge comprises an organosilane of structure (R¹O)₃Si—R²—Z, wherein Z is a leaving group. In various examples, Z is a halogen, such as —Cl. A residual antimicrobial coating comprises an organosilane of structure (R¹O)₃Si—R²—Z, wherein Z is a halogen X, and a tertiary organic amine R⁹R¹⁰R11N, wherein R⁹, R¹⁰, and R¹¹ are independently alkyl, substituted alkyl, aryl, substituted aryl or cyclic.

In various embodiments, a residual antimicrobial coating on a sponge comprises (R¹O)₃Si—R²—Z, wherein R¹ is H, alkyl, substituted alkyl, aryl, or substituted aryl, R² is —CH₂CH₂CH₂—, and Z is —Cl. In certain examples, the residual antimicrobial coating further comprises an organic amine.

In various embodiments, a residual antimicrobial coating on a sponge comprises (R¹O)₃Si—R²—Z, wherein R¹ is H or alkyl, R² is —CH₂CH₂CH₂—, and Z is —Cl, and at least one of diethanolamine and triethanolamine.

In various embodiments, a residual antimicrobial coating on a sponge comprises the adduct between (R¹O)₃Si—R²—Z, wherein R¹ is H, alkyl, substituted alkyl, aryl, or substituted aryl, R² is a bivalent linker, and Z is a leaving group —X, and an amine of structure R⁹R¹⁰ R¹¹N, wherein R⁹, R¹⁰, and R¹¹ are independently H, alkyl, substituted alkyl, aryl, substituted aryl, or cyclic, having the general structure:

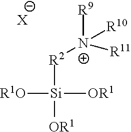

In various embodiments, R⁹, R¹⁰ and R¹¹ are each —CH₂CH₂OH, R² is any bivalent linker and X=halogen. In other examples, R⁹ and R¹⁰ are —CH₃, R¹¹ is -octadecyl, and X— is Cl—. In other examples, R⁹, are each —CH₂CH₂OH, R² is —CH₂CH₂CH₂—, X═Cl and R¹ is H or alkyl. In certain examples, R⁹, R¹⁰ and R¹¹ are each —CH₂CH₂OH, R² is —CH₂CH₂CH₂—, X═Cl, and R¹ is —H, —CH₃, or —CH₂CH₃.

In various embodiments, a residual antimicrobial coating on a sponge comprises the adduct between a choline salt and an organosilane (R¹O)₃Si—R²—Z, wherein R¹ is H, alkyl, substituted alkyl, aryl, or substituted aryl, R² is a bivalent linker, and Z is a leaving group. The choline salt may comprise choline chloride, choline bitartrate, or any other choline salt. In specific embodiments, a residual antimicrobial coating comprises the adduct between (R¹O)₃Si—R²—Z and a choline salt, wherein R¹ is H, alkyl, substituted alkyl, aryl, or substituted aryl, R² is a is —CH₂CH₂CH₂—, and Z is a leaving group, with the adduct in the coating having the structure (R¹O)₃Si—CH₂CH₂CH₂—O—CH₂CH₂—N(CH₃)₃⁺X⁻, wherein R¹ is H, alkyl, substituted alkyl, aryl, or substituted aryl, and X is Z, the counterion from the starting choline salt, or a mixed salt.

In various embodiments, a residual antimicrobial coating on a sponge comprises the adduct:

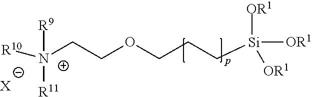

wherein R¹ is H, alkyl, substituted alkyl, aryl, or substituted aryl, R⁹, R¹⁰, and R¹¹ are independently H, alkyl, substituted alkyl, aryl, substituted aryl, or cyclic, X is selected from the group consisting of chlorine, bromine, iodine and bitartrate; and p is from 1 to 5.

In various embodiments, an antimicrobial coating formed from an antimicrobial coating composition comprising an organosilane (R¹O)₃Si—R²—Z and triethanolamine comprises the polymeric species:

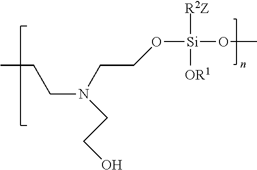

wherein R¹ is H, alkyl, substituted alkyl, aryl, or substituted aryl, R² is a bivalent linker of any molecular chain length and branching, which may comprise any number of methylene groups —(CH₂)ₙ—, optionally substituted with various substituents such as —OH, —SH, —OCH₃, or —CO₂H anywhere along the chain, and/or interrupted with intervening heteroatoms and/or degrees of unsaturation, and Z is a nucleophile, a leaving group or a quaternary nitrogen substituent, and n is from about 1 to about 10.

In various embodiments, an antimicrobial coating formed from an antimicrobial coating composition comprising an organosilane (R¹O)₃Si—R²—Z and triethanolamine comprises the polymeric species:

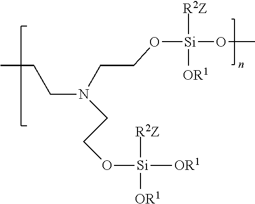

wherein R¹ is H, alkyl, substituted alkyl, aryl, or substituted aryl, R² is a bivalent linker of any molecular chain length and branching, which may comprise any number of methylene groups —(CH₂)ₙ—, optionally substituted with various substituents such as —OH, —SH, —OCH₃, or —CO₂H anywhere along the chain, and/or interrupted with intervening heteroatoms and/or degrees of unsaturation, and Z is a nucleophile, a leaving group or a quaternary nitrogen substituent, and n is from about 1 to about 10.

In various embodiments, an antimicrobial coating formed from an antimicrobial coating composition comprising an organosilane (R¹O)₃Si—R²—Z and triethanolamine comprises the polymeric species:

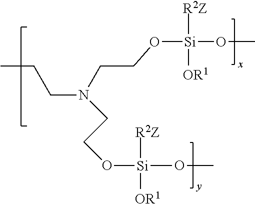

wherein R¹ is H, alkyl, substituted alkyl, aryl, or substituted aryl, R² is a bivalent linker of any molecular chain length and branching, which may comprise any number of methylene groups —(CH₂)ₙ—, optionally substituted with various substituents such as —OH, —SH, —OCH₃, or —CO₂H anywhere along the chain, and/or interrupted with intervening heteroatoms and/or degrees of unsaturation, and Z is a nucleophile, a leaving group or a quaternary nitrogen substituent, and x and y are independently from about 1 to about 10.

In various embodiments, a residual antimicrobial coating formed from an antimicrobial coating composition comprising an organosilane (R¹O)₃Si—R²—Z and triethanolamine comprises the polymeric species:

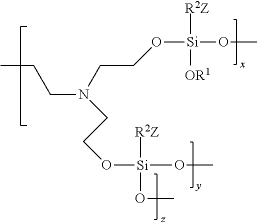

wherein R¹ is H, alkyl, substituted alkyl, aryl, or substituted aryl, R² is a bivalent linker of any molecular chain length and branching, which may comprise any number of methylene groups —(CH₂)ₙ—, optionally substituted with various substituents such as —OH, —SH, —OCH₃, or —CO₂H anywhere along the chain, and/or interrupted with intervening heteroatoms and/or degrees of unsaturation, and Z is a nucleophile, a leaving group or a quaternary nitrogen substituent, and x, y, and z are independently from about 1 to about 10.

In other embodiments, an antimicrobial coating composition comprises an orthosilicate of general structure (R¹O)₄Si, wherein R¹ is alkyl, substituted alkyl, aryl, or substituted aryl. In various embodiments, an antimicrobial coating composition comprises an orthosilicate (R¹O)₄Si and at least one organic amine R⁹R¹⁰R¹¹N, wherein R¹ is alkyl, substituted alkyl, aryl, or substituted aryl, and wherein R⁹, R¹⁰, and R¹¹ are independently H, alkyl, substituted alkyl, aryl, substituted aryl, or cyclic.

In various examples, an antimicrobial coating composition comprises an orthosilicate (R¹O)₄Si, and triethanolamine, wherein R¹ is alkyl, substituted alkyl, aryl, or substituted aryl. In certain examples, a residual antimicrobial coating formed from this antimicrobial coating composition comprises a crosslinked polymer network with a core structure:

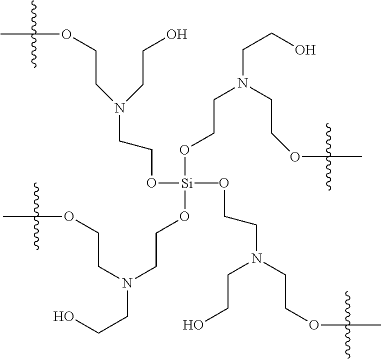

It is important to note that the polymer formed from an orthosilicate and triethanolamine comprises this structure regardless of the orthosilicate starting material, as noted from the absence of R¹ groups in the reaction product. The R¹O— substituents on silicon are exchanged with the hydroxyl substituents of the triethanolamine molecules.

In various examples, an antimicrobial coating composition comprises an orthosilicate (R¹O)₄Si, and diethanolamine, wherein R¹ is alkyl, substituted alkyl, aryl, or substituted aryl. A residual antimicrobial coating formed from this antimicrobial coating composition comprises a crosslinked polymer network with a core structure:

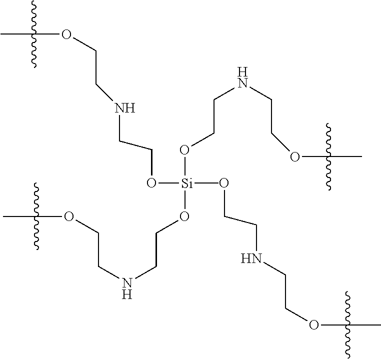

It is important to note that the polymer formed from an orthosilicate and diethanolamine has this networked structure regardless of the orthosilicate starting material, as noted from the absence of R¹ groups in the reaction product due to the exchange of R¹O— substituents on silicon with the hydroxyl substituents of the diethanolamine molecules.

TiO₂, Ti(OR³)₄, and Ti(OR³)₄ Adduct Coatings

In various embodiments, a residual antimicrobial coating is formed on a sponge by applying an antimicrobial coating composition comprising at least one Ti(IV) oxide such as TiO₂, a Ti(OR³)₄ species, or a dimer, trimer, tetramer or polymer reaction product thereof, or a Ti(OR³)₄ adduct, or a mixture of peroxotitanium acid and peroxo-modified anatase sol, on sponge substrate, followed by curing including ambient or elevated temperature drying, wherein R³ is alkyl, substituted alkyl, aryl or substituted aryl. As mentioned, formation of a residual antimicrobial coating may comprise this step of applying an antimicrobial coating composition comprising a Ti compound along with the application of at least one additional antimicrobial coating composition to the sponge. The at least one additional antimicrobial coating composition may be applied either before or after the application of the antimicrobial coating composition comprising the Ti compound(s). In examples where more than two coatings are applied to a sponge, the other antimicrobial coating compositions and the antimicrobial coating composition comprising the Ti compound(s) may be applied to the sponge in any ordered sequence across any timeframe. In various embodiments, the at least one other antimicrobial coating composition comprises an organosilane.

(a) TiO₂ Coatings:

In various embodiments, an antimicrobial coating composition comprises TiO₂ or any Ti composition, such as a sol, believed to form a TiO₂ thin film. The TiO₂ may be in any physical form, such as for example, anatase. TiO₂ for use in various embodiments may comprise rutile, anatase, brookite, hollandite-like, ramsdellite-like, a-PbO₂-like, baddeleyite-like form, orthorhombic TiO₂-OI, cubic, and/or cotunnite-like forms. The most common crystalline forms are anatase, brookite and rutile. Further, an antimicrobial coating composition may comprise a TiO₂ sol. Any of these Ti species may be used to form a residual antimicrobial thin film of TiO₂ on a sponge. To produce such a thin film on a sponge, e-beam evaporation, sputtering, chemical vapor deposition, electrostatic spray, or the hydrolytic sol-gel process may be used to form a thin film TiO₂ coating from an antimicrobial coating composition. In the latter example, a mixture of peroxotitanium acid and peroxo-modified anatase sol can be used as an antimicrobial coating composition within the scope of the present disclosure. Methods to prepare peroxotitanium acid solution and peroxo-modified anatase sol, useful for the low-temperature formation of TiO₂-containing thin films, is disclosed in Ichinose, H., et al., “Properties of Peroxotitanium Acid Solution and Peroxo-Modified Anatase Sol Derived From Peroxotitanium Hydrate,” J. Sol-Gel Sci. and Tech., 22(1), 33-40, 2001, and in Ichinose, H., et al., “Synthesis of Peroxo-Modified Anatase Sol from Peroxo Titanic Acid Solution,” Journal of the Ceramic Society of Japan, 104(8), 715-718, 1996. These references are incorporated herein by reference as to their teaching of methods to prepare a mixture of peroxotitanium acid solution (H₄TiO₄) and peroxo-modified anatase sol.

In certain examples, an antimicrobial coating composition comprises a colloidal suspension of from about 0.5 wt. % to about 50 wt. % TiO₂ in water. In other examples, an antimicrobial coating composition comprises an aqueous mixture of Ti—(O-i-C₃H₇)₄ usable to create a thin film of TiO₂ via the sol-gel process. Such compositions may also comprise an organic solvent, such as an alcohol like n-propanol or n-butanol, a surfactant, or an acid catalyst. In the sol-gel process, TiO₂ is prepared by hydrolysis, condensation and polycondensation of a titanium alkoxide, such as Ti—(O-i-C₃H₇)₄ or TiCl₄. A TiO₂ sol-gel composition, when coated onto a sponge provides a thin film TiO₂ coating on the sponge.

In various embodiments, a residual antimicrobial coating comprises TiO₂. In other examples, a residual antimicrobial coating comprises TiO₂ formed by coating a sponge with a colloidal suspension of TiO₂ particles. In certain examples, a residual antimicrobial coating comprises TiO₂ synthesized by the sol-gel process. In various embodiments, a residual antimicrobial coating comprising a mixture of peroxotitanium acid solution and peroxo-modified anatase sol.

(b) Ti(OR³)₄ Coatings:

In various embodiments, a coating composition comprises Ti(OR³)₄, wherein R³ is alkyl, substituted alkyl, aryl, or substituted aryl, and wherein the four separate R³ groups are identical or different. Examples of Ti(OR³)₄ include, but are not limited to, titanium tetramethoxide, titanium tetraethoxide, titanium methoxide triethoxide, titanium tetra-n-propoxide, titanium tetra-i-propoxide, and titanium tetraphenoxide. Depending on the physical properties of the titanium (IV) species, the compound may be used neat (e.g. Ti—(O-i-C₃H₇)₄) as an antimicrobial coating composition or dissolved in an alcohol or other organic solvent(s), such as the corresponding alcohol, where feasible, (methanol, ethanol, i-propanol, etc.). Thus, an antimicrobial coating composition may comprise a solution of Ti—(O-i-C₃H₇)₄ in isopropanol or some other alcohol.

In various embodiments, an antimicrobial coating composition comprises Ti(OR³)₄, wherein R³ is alkyl, substituted alkyl, aryl, or substituted aryl. In certain aspects, an antimicrobial coating composition further comprises a solvent selected from the group consisting of water, alkanols, diols, triols, chlorinated organic solvents, ethers, amines, esters, ketones, aldehydes, lactones, phenolics, and mixtures thereof. In certain examples, a solvent is selected from, but not limited to, water, methanol, ethanol, n-propanol, i-propanol, ethylene glycol, 1,2-propanediol, 1,3-propanediol, glycerin, methylene chloride, trichloromethane, carbon tetrachloride, ethylene glycol monoalkyl ether, ethylene glycol dialkylether, propylene glycol monoalkyl ether, propylene glycol dialkyl ether, ethylene glycol monophenyl ether, ethylene glycol diphenyl ether, propylene glycol monophenyl ether, propylene glycol diphenyl ether, diethylether, tetrahydrofuran, pyridine, triethanolamine, diethanolamine, triethylamine, ethylacetate, acetone, furfural, and N-methyl-2-pyrrolidone, and combinations thereof. In various examples, an antimicrobial coating composition consists essentially of Ti—(O-i-C₃H₇)₄. Other examples include an antimicrobial coating composition comprising Ti—(O-i-C₃H₇)₄ and an alcohol, and a composition comprising Ti—(O-i-C₃H₇)₄ and iso-propanol.

In various embodiments, an antimicrobial coating composition comprises Ti(OR³)₄, wherein each R³ is alkyl, substituted alkyl, aryl, or substituted aryl, is applied to the surfaces of a sponge in order to provide a residual antimicrobial coating on and within the sponge. The application method may be a spray method or a dip method of coating, optionally followed by expression of the excess liquid and drying. The wetted sponge may be allowed to dry at ambient, or under controlled conditions (e.g. at a particular % RH), or dried under heated conditions, (e.g. a thermal convection oven) to produce the residual antimicrobial coating on and within the sponge. The resulting dried coating is substantially free of all solvents. In various examples, an antimicrobial coating composition comprising Ti—(O-i-C₃H₇)₄ and an alcohol is applied to a sponge and the alcohol is allowed to evaporate, or alternatively, the sponge is optionally pressed and then dried, until the residual antimicrobial coating on the sponge has no more than about 5 wt. % alcohol remaining. In various embodiments, the amount of remaining alcohol after drying is no more than about 1 wt. %. In other embodiments, the amount of remaining alcohol after drying is negligible, (e.g. less than about 0.01 wt. %). In instances wherein the Ti(OR³)₄ species dimerizes, trimerizes, or polymerizes, the resulting moles of alcohol R³—OH is liberated from the surfaces of the sponge as the coating dries thereon.

In general, the bulkier the R³ groups on Ti(OR³)₄, the more likely the titanium species exists as a monomer, even when dried on a surface. On the other hand, Ti(OCH₃)₄, Ti(OCH₃)(OCH₂CH₃)₃, and Ti(OCH₂CH₃)₄, are known to exist as tetramers in the solid state. Polymerization takes place when titanium alkoxides are hydrolyzed to metal hydroxides or oxides. Thus, for example, the steric size of the R³ groups can be chosen, and the humidity present during drying/curing of a sponge can be controlled, such that monomeric, dimeric, trimeric, tetrameric or polymeric titanium species result on and within the cellular structure of the sponge.

In various embodiments, a residual antimicrobial coating on a sponge comprises Ti(OR³)₄, wherein each R³ is alkyl, substituted alkyl, aryl, or substituted aryl. In other embodiments, a residual antimicrobial coating on a sponge comprises the dimer:

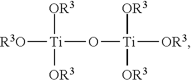

wherein each R³ is alkyl, substituted alkyl, aryl, or substituted aryl.

In various embodiments, a residual antimicrobial coating on a sponge comprises the trimer:

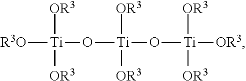

wherein each R³ is alkyl, substituted alkyl, aryl, or substituted aryl.

In various embodiments, a residual antimicrobial coating on a sponge comprises the tetramer:

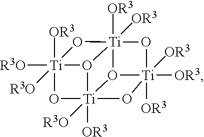

wherein each R³ is alkyl, substituted alkyl, aryl, or substituted aryl.

In various embodiments, a residual antimicrobial coating on a sponge comprises the linear polymer:

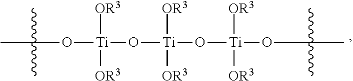

wherein each R³ is alkyl, substituted alkyl, aryl, or substituted aryl.

In various embodiments, a residual antimicrobial coating on a sponge comprises the crosslinked polymer:

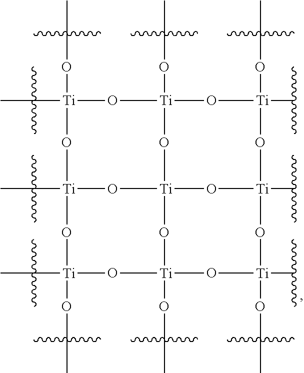

wherein each R³ is alkyl, substituted alkyl, aryl, or substituted aryl.

In various embodiments, a residual antimicrobial coating on a sponge comprises the polymeric species Ti₃₍ₓ₊₁₎O₄ₓ(OR³)₄₍ₓ₊₃₎, wherein x=0, 1, 2, . . . , ∞, and wherein R³ is a relatively sterically small substituent, such as methyl, ethyl, n-propyl, and i-propyl, or combinations of these R³ groups.

Other aspects of titanium alkoxide chemistry is disclosed in J. H. Clark, “The Chemistry of Titanium, Zirconium and Hafnium,” Pergamon Texts in Inorganic Chemistry, Volume 19, 1973, Pergamon Press, Oxford, England.

(c) Ti(OR³)₄ Adduct Coatings:

In various embodiments, an antimicrobial coating composition for a sponge may comprise a titanium (IV) alkoxide and a diol, α-hydroxy acid, or β-hydroxy acid, and optionally any excipient such as solvent, surfactant, acid, or base. These reactants may combine to form various adducts in solution (i.e. within the composition), or may form adducts while curing or once cured onto a sponge, such as on the fibers therein. In various examples, an antimicrobial coating composition comprises a titanium (IV) alkoxide, Ti(OR³)₄ wherein each R³ is alkyl, substituted alkyl, aryl, or substituted aryl, and a cis- or trans-1,2-diol, an α-hydroxy acid, or a β-hydroxy acid. When a small molecular weight alcohol is used as a solvent, the R³ groups on the Ti may or may not exchange out with the alcohol. Thus the examples provided below assume there is no alcohol used, or that the alcohol does not exchange out.

A 1,2-diol for use in various embodiments may comprise ethylene glycol, 1,2-propylene glycol, 1,2-dihydroxybutane, and so forth, or any diol of general structure R⁵R⁶C(OH)—C(OH)R⁷R⁸, wherein R⁵, R⁶, R⁷ and R⁸ are independently H, alkyl, substituted alkyl, aryl, or substituted aryl. Further, and in accordance to this general structure, a 1,2-diol may comprise a dicarboxylic acid having the general structure:

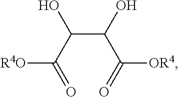

wherein R⁴═H, alkyl, substituted alkyl, aryl, or substituted aryl. In certain examples, the 1,2-diol comprises tartaric acid or the corresponding mono- or diester.

In other examples, an a-hydroxy acid, such as glycolic acid, lactic acid, citric acid, or mandelic acid, may be used. Further, a β-hydroxy acid, such as salicylic acid, 3-hydroxypropionic acid, or carnitine may be used.

In various examples, an antimicrobial coating composition comprises at least one of Ti(OR³)₄ wherein each R³ is alkyl, substituted alkyl, aryl, or substituted aryl, a cis- or trans-1,2-diol of formula R⁵R⁶C(OH)—C(OH)R⁷R⁸, and an adduct of general structure:

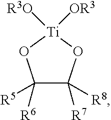

wherein R⁵, R⁶, R⁷ and R⁸ are independently H, alkyl, substituted alkyl, aryl, or substituted aryl.

In various examples, an antimicrobial coating composition comprises at least one of Ti(OR³)₄ wherein each R³ is alkyl, substituted alkyl, aryl, or substituted aryl, an α-hydroxy acid of formula R⁵R⁶C(OH)—CO₂H, and an adduct of general structure:

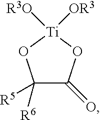

wherein R⁵, and R⁶ are independently H, alkyl, substituted alkyl, aryl, or substituted aryl.

In various examples, an antimicrobial coating composition comprises at least one of Ti(OR³)₄ wherein each R³ is alkyl, substituted alkyl, aryl, or substituted aryl, a β-hydroxy acid of formula R⁵R⁶C(OH)—C(R⁷)(R⁸)CO₂H, and an adduct of general structure:

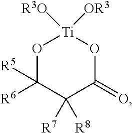

wherein R⁵, R⁶, R⁷ and R⁸ are independently H, alkyl, substituted alkyl, aryl, or substituted aryl.

In various embodiments, an antimicrobial composition comprising Ti(OR³)₄ wherein each R³ is alkyl, substituted alkyl, aryl, or substituted aryl, and a cis- or trans-1,2-diol, an α-hydroxy acid, or a β-hydroxy acid is applied to a sponge to provide a residual antimicrobial coating on the sponge. These compositions may be applied as discussed herein, such as by spray coating or dip coating. The coated sponge may then be cured, such as by ambient drying or oven drying.

In various embodiments, a residual antimicrobial coating comprises a titanium adduct of general structure:

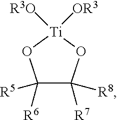

wherein R³ is alkyl, substituted alkyl, aryl, or substituted aryl and R⁵, R⁶, R⁷ and R⁸ are independently H, alkyl, substituted alkyl, aryl, or substituted aryl.

In various embodiments, a residual antimicrobial coating comprises a titanium adduct of general structure:

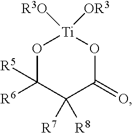

wherein R³ is alkyl, substituted alkyl, aryl, or substituted aryl and R⁵, R⁶, R⁷ and R⁸ are independently H, alkyl, substituted alkyl, aryl, or substituted aryl.

In various embodiments, a residual antimicrobial coating comprises a titanium adduct of general structure:

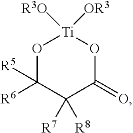

wherein R³ is alkyl, substituted alkyl, aryl, or substituted aryl and R⁵, R⁶, R⁷ and R⁸ are independently H, alkyl, substituted alkyl, aryl, or substituted aryl.

Coatings Comprising an at least One Organosilane and Triethanolamine (no Ti Species used in the Organosilane Composition or used to Treat the Sponge Before or After Organosilane Treatment)

In various embodiments, a sponge is treated with an aqueous solution comprising 3-(trimethoxysilyl) propyldimethyloctadecyl ammonium chloride (or 3-(hydroxysilyl) propyldimethyloctadecyl ammonium chloride), 3-chloropropyltrimethoxysilane (CPTMS), and triethanolamine. In other embodiments, a sponge is treated with an aqueous solution of 3-aminopropyltriethoxysilane (3-APTES) and triethanolamine. In these examples, no Ti species is used to treat the sponge, and the resulting antimicrobial and durability properties are due only to the organosilane and triethanolamine combination.

Coatings Comprising an Organosilane, Amine, and a Titanium Species, or Reaction Products Therefrom, and Organosilane and Amine Coatings in Combination with a Coating Comprising a Titanium Species

(a) Antimicrobial Coating Compositions Comprising an Organosilane, an Amine and a Titanium Species:

In various embodiments, an antimicrobial coating composition comprises a mixture of an organosilane structure (R¹O)₃Si—R²—Z, an amine R⁹R¹⁰R¹¹N, and a titanium species Ti(OR³)₄, wherein each R¹ is independently H, alkyl, substituted alkyl, aryl, or substituted aryl, R² is a bivalent linker, each R³ is independently alkyl, substituted alkyl, aryl, or substituted aryl, and R⁹, R¹⁰, and R¹¹ are independently H, alkyl, substituted alkyl, aryl, substituted aryl, or cyclic. In various embodiments, an antimicrobial coating composition comprises a mixture of an organosilane structure (R¹O)₃Si-3R²—Z, an amine R⁹R¹⁰R¹¹, and a mixture of peroxotitanium acid solution and peroxo-modified anatase sol, wherein each R¹ is independently H, alkyl, substituted alkyl, aryl, or substituted aryl, R² is a bivalent linker, and R⁹, R¹⁰, and R¹¹ are independently H, alkyl, substituted alkyl, aryl, substituted aryl, or cyclic.

In various examples, a titanium (IV) species comprises the species, Ti(OR³)₃O—(CH₂)_{q—R}¹², wherein R¹² comprises a chromophore and q is from about 1 to about 10. Chromophore R¹² may comprise any chromophore that upon exposure to electromagnetic irradiation having a first frequency emits electromagnetic radiation of a second frequency different from the first. In certain embodiments, the first frequency is within the UV spectrum and the second frequency is within the visible spectrum. In certain embodiments, R¹² comprises a triscyclometalated iridium (III) material that, upon exposure to UV irradiation, emits visible light. A titanium species such as Ti(OR³)₄ or Ti(OR³)₃O—(CH₂)_{q}—R¹² may be copolymerized with an organosilane.

When a sponge is treated with such a composition and the coating cured thereon, the resulting residual antimicrobial coating formed on the sponge may comprise any combination of unreacted organosilane, amine, and titanium species, along with various hydrolysis products, self-condensation products including homopolymers, intermolecular adducts, and intermolecular polymeric reaction products of various linear, branched and dendritic structures.

In various embodiments, a residual antimicrobial coating comprises a polymer having the structure:

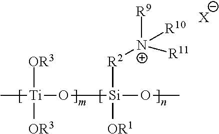

wherein each R¹ is independently H, alkyl, substituted alkyl, aryl, or substituted aryl, R² is a bivalent linker, each R³ is independently alkyl, substituted alkyl, aryl, or substituted aryl, and R⁹, R¹⁰, and R¹¹ are independently H, alkyl, substituted alkyl, aryl, substituted aryl, or cyclic, and m and n are independently from 1 to about 500.

In various embodiments, an antimicrobial coating composition comprises an organosilane (R¹O)₃Si—R²—Z, an amine R⁹R¹⁰R¹¹N, and a titanium species Ti(OR³)₃O—(CH₂)_{q}—R¹², wherein each R¹ is independently H, alkyl, substituted alkyl, aryl, or substituted aryl, R² is a bivalent linker, each R³ is independently alkyl, substituted alkyl, aryl, or substituted aryl, R⁹, R¹⁰, and R¹¹ are independently H, alkyl, substituted alkyl, aryl, substituted aryl, or cyclic, R¹² is a chromophore, and q is from about 1 to about 10.

When this antimicrobial coating composition is coated on a sponge and cured thereon, the resulting residual antimicrobial coating comprises a polymer having structure:

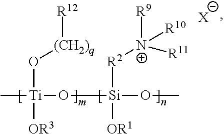

wherein each R¹ is independently H, alkyl, substituted alkyl, aryl, or substituted aryl, R² is a bivalent linker, each R³ is independently alkyl, substituted alkyl, aryl, or substituted aryl, R⁹, R¹⁰, and R¹¹ are independently H, alkyl, substituted alkyl, aryl, substituted aryl, or cyclic, R¹² is a chromophore, and q is from about 1 to about 10, and wherein m and n are independently from 1 to about 500. These polymers may comprise linear or crosslinked structures. In more specific examples, R² is —CH₂—, —CH₂CH₂—, —CH₂CH₂CH₂—, or —CH₂CH₂—O—CH₂(CH₂CH₂)p-, wherein q is from about 1 to about 10 and p is from 0 to about 5.

(b) Residual Antimicrobial Coatings Comprising an Organosilane and Amine Coating in Combination with a Coating Comprising a Titanium Species:

In certain aspects, a residual antimicrobial coating formed from an antimicrobial coating composition comprising an organosilane (R¹O)₃Si—R²—Z and an amine R⁹R¹⁰R¹¹N, may further comprise a coating obtained by using an antimicrobial coating composition comprising any titanium species including any form of TiO₂, any Ti (IV) oxide Ti(OR³)₄ or compounds such as Ti(OR³)₃O—(CH₂)_{q}—R¹², including a mixture of peroxotitanium acid solution and peroxo-modified anatase sol. The coating comprising the at least one titanium species may be disposed underneath or overtop of an organosilane/amine coating. For example, an organosilane/amine layer may be disposed between the surfaces of the sponge and the Ti species layer. There may be any number of organosilane/amine coatings and any number of titanium species coatings, disposed in any ordering of the layers. Further, any degree of curing may be used for any of the coatings, and each of the coatings may be spaced apart by any time period, such as seconds, minutes, hours, days, months, etc. As mentioned, multiple coating and curing operations are especially amenable to roll-to-roll coating of sponge sheet material, such as cellulose sheets.

As discussed, when various antimicrobial coating compositions dry and/or are cured by other methods on a sponge, reactions may take place between the organosilane and the amine, between the amine and the titanium species, between the organosilane and the titanium species, or between all three. In various embodiments, the chemical nature of a sponge may take part in catalyzing certain reactions.

Organosilane Coating, Overcoated or Undercoated with a Titanium Species

In certain aspects, a residual antimicrobial coating formed from an antimicrobial coating composition comprising an organosilane (R¹O)₃Si—R²—Z may further comprise a coating obtained by casting an antimicrobial coating composition comprising any titanium species including any form of TiO₂, any Ti (IV) oxide Ti(OR³)₄ or compounds such as Ti(OR3)₃O—(CH₂)_{q}—R¹², including disposing a mixture of peroxotitanium acid solution and peroxo-modified anatase sol. The coating comprising the at least one titanium species may be disposed underneath or overtop of an organosilane coating. There may be any number of organosilane coatings and titanium species coatings, disposed in any order of the layers.

Further, any degree of curing may be used for any of the coatings, and each of the coatings may be spaced apart by any time period, such as seconds, minutes, hours, days, months, etc. As mentioned, multiple coating and curing operations are especially amenable to roll-to-roll coating of cellulosic sheet substrate.

As discussed, when various antimicrobial coating compositions dry and/or are cured by other methods on a sponge, reactions may take place between the organosilane and the titanium species, and any one of these reactions may be assisted by the chemical nature of the sponge and what substances are already present in an untreated sponge.

Grafted Parylene Polymer Coatings

Palladium Catalyzed Amination of Parylene C:

In various embodiments, an antimicrobial coating composition comprises the reaction product between parylene C and at least one organosilane (R¹O)₃Si—R²—Z, wherein each R¹ is independently H, alkyl, substituted alkyl, aryl, or substituted aryl, R² is a bivalent linker and Z is —NH₂. The grafted polymer may be produced by the Buchwald-Hartwig cross-coupling reaction, whereby the organosilane (R¹O)₃Si—R²—Z is reacted with parylene C in the presence of a palladium catalyst such as PdCl₂ (dppf). The polymer thus obtained comprises the structure:

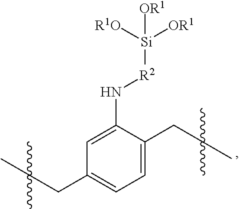

wherein each R¹ is independently H, alkyl, substituted alkyl, aryl, or substituted aryl, and R² is a bivalent linker.

An antimicrobial coating composition comprising this polymer may be applied to a sponge using any of the methods described herein.

In various embodiments of the present invention, a coating composition comprises a polymer:

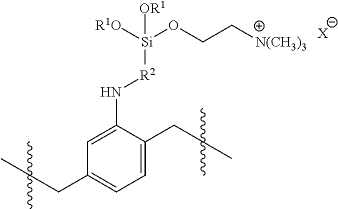

wherein R¹ is independently H, alkyl, substituted alkyl, aryl, or substituted aryl, R² is a bivalent linker, and X is chloride or bitartrate. This parylene polymer may be produced by reacting the grafted polymer with a choline salt such as choline chloride or choline bartartrate. An antimicrobial coating composition comprising this polymer may be applied to a sponge by any of the methods described herein.

Other Grafted Parylene Polymers:

Other grafted polymers based on the parylene structure may be envisioned, and may use parylene C, parylene D or any other parylene as the starting material and an organosilane of general structure (R¹O)₃Si—R²—Z, wherein each R¹ is independently H, alkyl, substituted alkyl, aryl, or substituted aryl, R² is a bivalent linker and Z is a nucleophile or leaving group.

### EXAMPLES

General Considerations

In general, the results on sponges varied with organosilane composition used to treat the sponge (2015 or 2030, detailed below), the total CFU count in the bacterial inoculum, the contact time the inoculum was left incubating in the sponge, and the organism used to test the efficacy of the treated sponge. Typically, Gram-negative organisms (e.g. E. coli), have the tendency to survive better against biocides in suspension because of the presence of an outer membrane. Additionally, sponge material such as cellulose likely carry a net negative charge when hydrated, making the organism less susceptible to a biocide bonded to surfaces in a treated cellulosic sponge. Overall, the antimicrobial efficacy of an organosilane treated sponge against E. coli was less than the efficacy against S. epidermidis.

Antimicrobial Coating Compositions used to Treat Test Sponges

One of two different organosilane compositions was used to treat the sponge, as follows and as indicated in each experiment:

“2015 Composition”: An aqueous mixture consisting of 0.75 wt. % 3-(trihydroxysilyl) propyldimethyloctadecyl ammonium chloride; 0.12 wt. % 3-chloropropyltrimethoxysilane; and 0.045 wt. % triethanolamine, each weight percentage based on the total weight of the composition, with the remainder consisting of only water. As used herein, the shorthand “2015 antimicrobial sponge” refers to a dry sponge that was previously treated with the 2015 aqueous composition shown here and then dried.

“2030 Composition”: An aqueous mixture consisting of 9.41 wt. % 3-aminopropyltriethoxysilane and 0.31 wt. % triethanolamine, each weight percentage based on the total weight of the composition, with the remainder consisting of only water. As used herein, the shorthand “2030 antimicrobial sponge” refers to a dry sponge that was previously treated with the 2030 aqueous composition shown here and then dried.

Sponge Substrates

Sponge materials used in the tests measured 1 in³ (16.4 cm³). The sponges tested comprised polyester, polyurethane, and cellulose sponges. The cellulose sponges were specifically chosen not to have any prior antimicrobial treatment.

Test Organisms

S. epidermidis ATCC 12228 and E. coli ATCC 25922. Contact times of 1, 2, 4 or 24 hours, and incubation temperatures at either 21° C. or 37° C.

Preparation of Antimicrobial Sponges

1. The test sponge was placed in a sealable polyethylene plastic bag.

2. 10 mL of the composition to be used was serologically pipetted on the sponge in a slow drip so as to avoid over-saturation and runoff.

3. The bag was sealed and then squeezed to exchange the air within the sponge with the test composition.

4. The wetted sponge was left at room temperature in the sealed bag for 1 day. After 1 day the bag was opened and the sponge removed.

5. Depending on the example, the sponge was optionally wrung out to express all the liquid possible. When wrung out, about 1.5 to 2 mL of composition remained in the polyester and polyurethane sponges, and about 6 to 7 mL remained in the cellulose sponges. There was no difference in the volume of liquid composition remaining trapped in the sponge between the two compositions.

6. The damp sponge was left out to dry at ambient conditions for more than 1 day before use in any antimicrobial testing. If sponges were not wrung out sufficiently, or not wrung out at all, they were optionally dried as indicated on a heater at 60° C. to accelerate drying.

Sanitizer Tests in General

Experiments were conducted according to AATCC 100 protocol, modified as necessary.

2015- and 2030-Coated Sponge Surface Inoculation with S. epidermidis

These sponges were squeezed to release excess liquid composition prior to ambient drying. The antimicrobial sponges were inoculated with 10⁶ CFU, and incubated at 37° C. for up to 2 hours as indicated in the examples.

1. A culture of S. epidermidis ATCC 12228 was initiated by inoculating a colony from a tryptic soy agar (TSA) into 20 ml of tryptic soy broth (TSB), and incubated for 24 hours at 37° C.

2. The 24 hours culture was diluted 1:1000 in TSB (10⁶ CFU/ml).

3. The 2015 and 2030 antimicrobial sponges and uncoated control sponges were pushed down in the center using the pipettor and inoculated with 1 ml of test culture (about 1×10⁶ CFU/sponge). As the pipettor was lifted, the bacteria was released, being absorbed by the sponge as it regained its shape. This ensured complete uptake of bacteria over the roughly 1 in³ surface.

4. One set of untreated control sponges was harvested immediately (zero hour) by immersing in 100 ml D/E broth, shaken by hand for 1 min, serially diluted 10⁻² to 10⁻³ in PBS buffer, and pour plated with cooling TSA. Other sponges were kept in sealed jars at 37° C. in an incubator.

5. At completion of 1 h contact (2030 antimicrobial sponges) and 2 h contact (2015 antimicrobial sponges), the sponges were neutralized. Untreated sponges were plated 10⁻² to 10⁻³, and antimicrobial sponges were plated 10° to 10⁻².

6. The plates were inverted and incubated at 37° C. for 48 hours, and then scored by directly counting the colonies.

7. Log₁₀ and percent reductions were calculated relative to the timed controls.

2015- and 2030-Coated Sponge Surface Inoculation with E. coli

These sponges were not squeezed out, but were instead subject to drying conditions indicated in the examples. The antimicrobial sponges were inoculated with 10⁵ CFU, and incubated at 37° C. for up to 24 hours.

1. A culture of E. coli ATCC 25922 was initiated by inoculating a colony from a tryptic soy agar (TSA) into 20 ml of tryptic soy broth (TSB), and incubated for 24 hours at 37° C.

2. The 24 hours culture was diluted 1:10000 in TSB (10⁵ CFU/ml).

3. The 2015 and 2030 antimicrobial sponges and uncoated sponges were pushed down in the center using the pipettor and inoculated with 1 ml of test culture (about 1×10⁵ CFU/sponge). As the pipettor was lifted, the bacteria was released, being absorbed by the sponge as it regained its shape. This ensured complete uptake of bacteria over the roughly 1 in³ surface.

4. One set of uncoated control sponges was harvested immediately (zero hour) by immersing in 100 ml D/E broth, shaken by hand for 1 min, serially diluted 10⁻² to 10⁻³ in PBS buffer, and pour plated with cooling TSA. Antimicrobial sponges were kept in sealed jars at 37° C. in an incubator.

5. At completion of 2 and 24 h contact (2030 sponges) and 4 and 24 h contact (2015 sponges), the sponges were neutralized. Uncoated sponges were plated 10⁻² to 10⁻³, and coated sponges were plated 10° to 10⁻².

6. The plates were inverted and incubated at 37° C. for 48 hours, and then scored by directly counting the colonies.

7. Log₁₀ and percent reductions were calculated relative to the timed controls.

2015-Coated Sponge Surface Inoculation with E. coli

These sponges were not squeezed out but were instead dried under the conditions indicated in the examples. Antimicrobial sponges were inoculated with 10⁵ CFU, and incubated at 21° C. for up to 24 hours.

1. A culture of E. coli ATCC 25922 was initiated by inoculating a colony from a tryptic soy agar (TSA) into 20 ml of tryptic soy broth (TSB), and incubated for 24 hours at 37° C.

2. The 24 hours culture was diluted 1:10000 in TSB (10⁵ CFU/ml).

3. The 2015 and 2030 coated sponges and uncoated sponges were pushed down in the center using the pipettor and inoculated with 1 ml of test culture (about 1×10⁵ CFU/sponge). As the pipettor was lifted, the bacteria was released, being absorbed by the sponge as it regained its shape. This ensured complete uptake of bacteria over the roughly 1 in³ surface.

4. One set of uncoated control sponges was harvested immediately (zero hour) by immersing in 100 ml D/E broth, shaken by hand for 1 min, serially diluted 10⁻² to 10⁻³ in PBS buffer, and pour plated with cooling TSA. Other sponges were kept in sealed jars at 21° C. on the lab bench.

5. At completion of 4 and 24 h contact, the sponges were neutralized. Uncoated sponges were plated 10⁻² to 10⁻³, and coated sponges were plated 10° to 10⁻².

6. The plates were inverted and incubated at 37° C. for 48 hours, and then scored by directly counting the colonies.

7. Log₁₀ and percent reductions were calculated relative to the timed controls.

### Example 1

### Efficacy of 2015 and 2030 Antimicrobial Sponges against S. epidermidis ATCC 12228

2015 and 2030 antimicrobial sponges were challenged with S. epidermidis ATCC 12228. Untreated sponges were submerged in sealable bags containing 10 mL of either 2015 or 2030 compositions. After 1 day, the sponges were squeezed out, liberating about 8 mL of liquid and retaining about 2 mL of liquid. The wet sponges were they dried for at least a day at ambient prior to any microbial testing. For the challenges, sponges were inoculated with 1×10⁶ CFU/mL S. epidermidis, which was poured onto each sponge. The inoculated sponges were then incubated at 37° C. for the time period indicated (1 or 2 hours). TABLE 1 sets forth the results obtained. Most notably, the 2030 polyester antimicrobial sponge exhibited a 3.72 Log₁₀ reduction, the polyurethane 2030 antimicrobial sponge exhibited a remarkable and unexpected reduction of greater than 4 log (4.02 Log₁₀ reduction), and the cellulose 2030 antimicrobial sponge exhibited a 2.84 Log₁₀ reduction of S. epidermidis after 1-hour sponge/bacteria contact time.

TABLE 1
Efficacy of treated sponges against S. epidermidis ATCC 12228
Sponge Antimicrobial Efficacy Test - S. epidermidis ATCC 12228

| | | | | Log₁₀ | |
|---|---|---|---|---|---|
| | | Contact | | Re- | Percent |
| Sponge | Antimicrobial | Time | Geo. mean | duc- | Re- |
| Material | Coating | (hrs.) | (CFU/carrier) | tion | duction |
| Polyester | None | 0 | 2.60E+06 | N/A | |
| | | 1 | 2.35E+06 | N/A | |
| | | 2 | 1.82E+06 | N/A | |
| | 2015 | 2 | 3.04E+04 | 1.78 | 98.33% |
| | 2030 | 1 | 4.48E+02 | 3.72 | 99.98% |
| Polyurethane | None | 0 | 2.14E+06 | N/A | |
| | | 1 | 2.20E+06 | N/A | |
| | | 2 | 3.27E+06 | N/A | |
| | 2015 | 2 | 4.47E+03 | 2.86 | 99.86% |
| | 2030 | 1 | 2.08E+02 | 4.02 | 99.99% |
| Cellulose | None | 0 | 1.53E+06 | N/A | |
| | | 1 | 4.42E+05 | N/A | |
| | | 2 | 1.02E+06 | N/A | |
| | 2015 | 2 | 7.44E+02 | 3.14 | 99.93% |
| | 2030 | 1 | 6.34E+02 | 2.84 | 99.86% |

### Example 2

### Efficacy of 2015 and 2030 Antimicrobial Sponges against E. coli ATCC 25922 at 2 and 4 Hours Contact Time

2015 and 2030 antimicrobial sponges were prepared by soaking in 10 mL of the corresponding antimicrobial coating composition. However, in this example, the excess liquid coating composition was not expressed back out from the test sponge. Instead, the sponges were dried on a heater to demonstrate a commercial process that could be conducted on large rolls of sponge material. The dried sponges, comprising a dried antimicrobial coating on the sponge surfaces, were then inoculated with a 1×10⁵ CFU/mL E. coli bacteria culture. The more dilute culture used in this example was to at least somewhat simulate a more realistic home environment where a kitchen sponge may not be exposed to great levels of bacteria on average by just washing food residue from dishes.

TABLE 2 sets forth the results obtained at 2 and 4 hours contact time as indicated. As shown in the table, the 2030 antimicrobial sponge (i.e. prepared from aqueous 3-aminopropyltriethoxysilane and triethanolamine 2030 composition) performed well, exhibiting a 3.33 Log₁₀ reduction for polyester, a 2.83 Log₁₀ reduction for polyurethane, and a 2.18 Log₁₀ reduction for cellulose. The 2015 antimicrobial sponge underperformed, especially if the sponge comprised cellulose.

TABLE 2
Efficacy of antimicrobial sponges against E. coli ATCC 25922 at 2-
and 4-hour bacteria/sponge contact times
Sponge Antimicrobial Efficacy Test - E. coli ATCC 25922

| | | | | Log₁₀ | |
|---|---|---|---|---|---|
| | | Contact | | Re- | Percent |
| Sponge | Antimicrobial | Time | Geo. mean | duc- | Re- |
| Material | Coating | (hrs.) | (CFU/carrier) | tion | duction |
| Polyester | None | 0 | 2.45E+05 | N/A | |
| | | 2 | 7.16E+05 | N/A | |
| | | 4 | 4.71E+07 | N/A | |
| | 2015 | 4 | 1.47E+05 | 2.51 | 99.69% |
| | 2030 | 2 | 3.32E+02 | 3.33 | 99.95% |
| Polyurethane | None | 0 | 1.66E+05 | N/A | |
| | | 2 | 5.65E+05 | N/A | |
| | | 4 | 1.18E+07 | N/A | |
| | 2015 | 4 | 4.60E+05 | 1.41 | 96.11% |
| | 2030 | 2 | 8.43E+02 | 2.83 | 99.85% |
| Cellulose | None | 0 | 5.02E+05 | N/A | |
| | | 2 | 1.50E+04 | N/A | |
| | | 4 | 9.12E+06 | N/A | |
| | 2015 | 4 | 1.97E+06 | 0.67 | 78.41% |
| | 2030 | 2 | 1.00E+02 | 2.18 | 99.33% |

### Example 3

### Efficacy of 2015 and 2030 Antimicrobial Sponges against E. coli ATCC 25922 at 4 and 24 Hours Contact Time

In this example, the E. coli bacteria challenges were repeated on only the 2015 antimicrobial sponges. The sponge/bacteria contact times were 4 and 24 hours. A key difference in this example was the temperature at which the bacteria were left in contact with the sponge. Once inoculated, the sponges were incubated at 21° C. (rather than at 37° C.) for 4 and 24 hours in order to simulate the environment in a consumer's home where a kitchen sponge would likely be sitting beside the sink at room temperature for several hours or overnight. The results are set forth in TABLES 3 and 4. Although the 4-hour data was meaningful, there was overgrowth of E. coli in the untreated group after 24 hours, eliminating any possible measurement of E. coli reduction for the 2015 antimicrobial sponge after 24 hours.

TABLE 3
Efficacy of 2015 antimicrobial sponges against E. coli ATCC 25922 at
4-hour bacteria/sponge contact times
Sponge Antimicrobial Efficacy Test - E. coli ATCC 25922

| | | | | Log₁₀ | |
|---|---|---|---|---|---|
| | | Contact | | Re- | Percent |
| Sponge | Antimicrobial | Time | Geo. mean | duc- | Re- |
| Material | Coating | (hrs.) | (CFU/carrier) | tion | duction |
| Polyester | None | 0 | 3.79E+05 | N/A | |
| | | 4 | 1.69E+06 | N/A | |
| | 2015 | | 8.63E+04 | 1.29 | 94.89% |
| Polyurethane | None | 0 | 4.76E+05 | N/A | |
| | | 4 | 1.70E+06 | N/A | |
| | 2015 | | 5.67E+04 | 1.48 | 96.67% |
| Cellulose | None | 0 | 1.61E+05 | N/A | |
| | | 4 | 2.70E+05 | N/A | |
| | 2015 | | 4.13E+04 | 0.81 | 84.68% |

TABLE 4
Efficacy of 2015 antimicrobial sponges against E. coli ATCC 25922 at
24-hour bacteria/sponge contact times
Sponge Antimicrobial Efficacy Test - E. coli ATCC 25922

| | | | | Log₁₀ | |
|---|---|---|---|---|---|
| | | Contact | | Re- | Percent |
| Sponge | Antimicrobial | Time | Geo. mean | duc- | Re- |
| Material | Coating | (hrs.) | (CFU/carrier) | tion | duction |
| Polyester | None | 0 | 2.90E+05 | N/A | |
| | | 24 | 5.00E+08 | N/A | |
| | 2015 | | Too numerous | — | — |
| | | | to count | | |
| Polyurethane | None | 0 | 3.29E+05 | N/A | |
| | | 24 | 5.00E+08 | N/A | |
| | 2015 | | Too numerous | — | — |
| | | | to count | | |
| Cellulose | None | 0 | 1.22E+05 | N/A | |
| | | 24 | 5.00E+08 | N/A | |
| | 2015 | | Too numerous | — | — |
| | | | to count | | |

In conclusion, an antimicrobial sponge comprising a porous sponge substrate and a composition comprising 3-aminopropyltriethoxysilane and triethanolamine dried therein, exhibits a fairly remarkable level of microbial kill when tested against S. epidermidis and E. coli.

Antimicrobial coating compositions, methods for applying antimicrobial coating compositions to sponges, including natural and synthetic sponges and cellulosic sheet substrate, and residual antimicrobial coatings having prolonged antimicrobial efficacy are provided. References to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

All structural, chemical, and functional equivalents to the elements of the above-described various embodiments that are known to those of ordinary skill in the art are expressly incorporated herein by reference and are intended to be encompassed by the present claims. Moreover, it is not necessary for a composition or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a chemical, chemical composition, process, method, article, or apparatus that comprises a list of elements does not include only those elements but may include other elements not expressly listed or inherent to such chemical, chemical composition, process, method, article, or apparatus.

We claim:

1. An antimicrobial sponge comprising:
a porous sponge substrate; and
an antimicrobial coating composition dried therein, the composition comprising:
at least one organosilane of formula (R¹O)₃Si—R²—Z; and an organic amine of formula R⁹R¹⁰R¹¹N,
wherein each R¹ is independently H, alkyl, substituted alkyl, aryl, or substituted aryl, R² is a bivalent linker, and Z is a nucleophile, a leaving group or a quaternary nitrogen substituent, and
wherein R⁹, R¹⁰, and R¹¹ are independently H, alkyl, substituted alkyl, aryl, substituted aryl or cyclic.

2. The antimicrobial sponge of claim 1, wherein the porous sponge substrate comprises a natural animal sponge, a natural plant sponge, or a synthetic sponge.

3. The antimicrobial sponge of claim 2, wherein the synthetic sponge comprises a polyester sponge, a polyurethane sponge, or a cellulose sponge.

4. The antimicrobial sponge of claim 1, wherein each R¹ is independently H or alkyl, R² is —CH₂CH₂CH₂—, and Z is —NH₂.

5. The antimicrobial sponge of claim 1, wherein each R¹ is independently H or alkyl, R² is —CH₂CH₂CH₂—, and Z is a halogen.

6. The antimicrobial sponge of claim 1, wherein each R¹ is independently H or alkyl, and Z is —N(CH₃)₂(n-C₁₈H₃₇)⁺X⁻, wherein X⁻ is a halogen.

7. The antimicrobial sponge of claim 1, wherein the organic amine comprises at least one of diethanolamine and triethanolamine.

8. The antimicrobial sponge of claim 1, wherein the organosilane is selected from the group consisting of 3-(trimethoxysilyl) propyldimethyloctadecylammonium chloride, 3-(trihydroxysilyl) propyldimethyloctadecylammonium chloride, 3-chloropropyltrimethoxysilane, 3-chloropropylsilanetriol, 3-aminopropyltriethoxysilane, 3-aminopropylsilanetriol, and mixtures thereof, and wherein the organic amine comprises triethanolamine.

9. The antimicrobial sponge of claim 1, wherein the antimicrobial coating composition dried therein consists essentially of 3-(trihydroxysilyl) propyldimethyloctadecylammonium chloride, 3-chloropropyltrimethoxysilane, and triethanolamine.

10. The antimicrobial sponge of claim 9, wherein the porous sponge substrate comprises a cellulose sponge, and wherein the antimicrobial sponge exhibits a greater than 3 log kill of S. epidermidis ATCC 12228 2 hours after inoculation of the antimicrobial sponge with a culture of S. epidermidis ATCC 12228.

11. The antimicrobial sponge of claim 1, wherein the antimicrobial coating composition dried therein consists essentially of 3-aminopropyltriethoxysilane and triethanolamine.

12. The antimicrobial sponge of claim 11, wherein the porous sponge substrate comprises a cellulose sponge, and wherein the antimicrobial sponge exhibits a greater than 4 log kill of S. epidermidis ATCC 12228 1 hour after inoculation of the antimicrobial sponge with a culture of S. epidermidis ATCC 12228.

13. The antimicrobial sponge of claim 11, wherein the porous sponge substrate comprises a cellulose sponge, and wherein the antimicrobial sponge exhibits a greater than 2 log kill of E. coli ATCC 25922 2 hours after inoculation of the antimicrobial sponge with a culture of E. coli ATCC 25922.

14. A method of preparing an antimicrobial sponge, the method comprising:
soaking a porous sponge substrate in an aqueous antimicrobial coating composition comprising:
(i) at least one of 3-(trimethoxysilyl) propyldimethyloctadecylammonium chloride, 3-(trihydroxysilyl) propyldimethyloctadecylammonium chloride, 3-chloropropyltrimethoxysilane, 3-chloropropylsilanetriol, 3-aminopropyltriethoxysilane, and 3-aminopropylsilanetriol;
(ii) triethanolamine; and
(iii) water;
optionally expressing the aqueous antimicrobial coating composition out from the porous sponge substrate; and
drying the porous sponge substrate to obtain the antimicrobial sponge.

15. The antimicrobial sponge of claim 14, wherein the porous sponge substrate comprises a natural animal sponge, a natural plant sponge, or a synthetic sponge.

16. The antimicrobial sponge of claim 15, wherein the synthetic sponge comprises a polyester sponge, a polyurethane sponge, or a cellulose sponge.

17. The method of claim 16, wherein the aqueous antimicrobial coating composition comprises 3-(trihydroxysilyl) propyldimethyloctadecylammonium chloride, 3-chloropropyltrimethoxysilane, and triethanolamine.

18. The method of claim 16, wherein the aqueous antimicrobial coating composition consists essentially of 0.75 wt. % 3-(trihydroxysilyl) propyldimethyloctadecylammonium chloride, 0.12 wt. % 3-chloropropyltrimethoxysilane, and 0.045 wt. % triethanolamine, remainder water, wherein the weight percentages are based on the total weight of the composition.

19. The method of claim 16, wherein the aqueous antimicrobial coating composition comprises 3-aminopropyltriethoxysilane, triethanolamine, and water.

20. The method of claim 19, wherein the aqueous antimicrobial coating composition consists essentially of 9.41 wt. % 3-aminopropyltriethoxysilane and 0.31 wt. % triethanolamine, remainder water, wherein the weight percentages are based on the total weight of the composition.
